(19) United States
(12) Patent Application Publication
(10) Pub. No.: US 2012/0078404 A1
(43) Pub. Date: Mar. 29, 2012

(54) CONSUMPTION RATE CALCULATING DEVICE, METHOD FOR CONTROLLING CONSUMPTION RATE CALCULATING DEVICE, AND CONTROL PROGRAM

(75) Inventors: Hiroshi SAITO, Kyoto (JP); Taisuke TATEISHI, Kyoto (JP)

(73) Assignee: OMRON CORPORATION, Kyoto (JP)

(21) Appl. No.: 13/248,493

(22) Filed: Sep. 29, 2011

Related U.S. Application Data
(63) Continuation of application No. PCT/JP2010/001404, filed on Mar. 2, 2010.

(30) Foreign Application Priority Data
Apr. 10, 2009 (JP) 2009/096321

(51) Int. Cl. G06F 19/00

(52) U.S. Cl. 700/97

(57) ABSTRACT

An operation information outputter includes a power data acquirer that acquires time-series data of a physical quantity consumed or generated when production equipment executes a process, a single-cycle detector that detects time-series data of predetermined duration out of the time-series data acquired by the power data acquirer, a production-quantity calculator that calculates a production quantity of objects to be produced by the production device in a specific period using the time-series data detected by the single-cycle detector, and a power-consumption-rate calculator that calculates the consumption rate of the physical quantity using the time-series data of the physical quantity for the specific period and the production quantity calculated by the production-quantity calculator, and makes it possible to achieve a consumption rate calculator or the like that easily calculates an energy consumption rate.

### CROSS-REFERENCE TO RELATED APPLICATIONS

This is a continuation application of PCT/JP/2010/001404 filed Mar. 2, 2010, designating the United States of America, the disclosure of which, including the specification, drawings, and claims, is expressly incorporated by reference in its entirety. The disclosure of Japanese Patent Application No. 2009-096321, filed on Apr. 10, 2009, including the specification, drawings, and claims is expressly incorporated by reference in its entirety.

### TECHNICAL FIELD

The present invention relates to a consumption rate calculator that outputs a consumption rate of a physical quantity for production equipment in production lines, a method that controls the consumption rate calculator, and a program that controls the same.

### BACKGROUND TECHNOLOGY

Conventionally, at machining factories, a plurality of production equipment is placed in line to perform multiple steps required to produce products, providing a production line that produces products in a flow process. Further, in fields of production management that manages the production lines, it is always required to improve productivity in the production lines and to promote energy saving, such as a reduction of power consumption and the like.

To improve productivity and energy efficiency in the production lines, it is necessary to understand statuses of the production lines. Thus, for example, Patent Literature 1 discloses a technology that acquires a stop signal when a machine stops, and automatically sorts a stoppage cause into a predetermined category based on the stop signal.

In addition, in order to improve productivity and energy efficiency in the production lines, it is important to understand how much energy is consumed per product. Thus, for example, Patent Literature 2 discloses a technology that, in a production facility that produces a plurality of different products, calculates an energy consumption rate for each product to be produced in the production facility based on an amount of energy consumed per unit time and a production quantity per product.

In addition, Patent Literature 3 discloses a device that manages an environmental load in each production process and evaluates the environmental load throughout a product life cycle. This device calculates a total environmental load that corresponds to the number of products commensurate with a predetermined period, based on an environmental load generated during an operation of a process, an environmental load generated during a preparation of a process, product information of products, and operation information of facility.

### RELATED ART

### Patent Literatures

Patent Literature 1: Japanese Patent Laid-open Publication No. H7-323523 (Published on Dec. 12, 1995) Patent Literature 2: Japanese Patent Laid-open Publication No. 2005-56262 (Published on Mar. 3, 2005) Patent Literature 3: Japanese Patent Laid-open Publication No. 2006-244374 (Published on Sep. 14, 2006)

### SUMMARY OF THE INVENTION

[Shortcomings Resolved by the Invention]

In order to calculate an energy consumption rate with the conventional configuration, as shown in FIG. 24(a), it is necessary to calculate a production quantity based on information output from a PLC (Programmable Logic Controller) that controls production equipment, and then calculate the energy consumption rate using an electric energy output from a power meter. Alternatively, as shown in FIG. 24(b), it is necessary to calculate a production quantity based on an output from a kind of sensor connected to the production equipment, and then calculate the energy consumption rate based on the calculated production quantity and an electric energy output from a power meter.

Thus, in order to calculate the energy consumption rate without changing the conventional configuration, it is necessary to create or modify a ladder program of the PLC so as to calculate the production quantity. Alternatively, a sensor and a counter for counting a production quantity are required.

In the configuration described in Patent Literature 2, in order to calculate the energy consumption rate, it is necessary to acquire a production quantity for each product using a kind of method. Therefore, a device needs to be provided so as to acquire the production quantity.

Moreover, Patent Literatures 1 and 3 do not disclose a physical quantity consumption rate, such as an energy consumption rate and the like.

In order to address the circumstances above, a purpose of the present invention includes achieving a consumption rate calculator that easily calculates a consumption rate of physical quantity.

[Object of the Invention]

In order to address the circumstances above, a consumption rate calculator according to the present invention includes a physical quantity acquirer that acquires time-series data of a physical quantity consumed or generated when production equipment performs a process; a data detector that detects time-series data of predetermined duration out of the time series data of the physical quantity acquired by the physical quantity acquirer; a production quantity calculator that calculates the production quantity of objects to be produced by the production equipment in a specific period using the time-series data detected by the data detector; and a consumption rate calculator that calculates a consumption rate of the physical quantity using the time-series data of the physical quantity for the specific period and the production quantity calculated by the production quantity calculator.

A method that controls the consumption rate calculator according to the present invention includes a physical quantity acquiring step that acquires time-series data of a physical quantity consumed or generated when production equipment performs a process; a data detecting step that detects time-series data of predetermined duration out of the time-series data of the physical quantity acquired in the physical quantity acquiring step; a production quantity calculating step that calculates a production quantity of objects to be produced by the production equipment in a specific period using the time-series data detected in the data detecting step; and a consumption rate calculating step that calculate a consumption rate of the physical quantity using the time-series data of the physical quantity for the specific period and the production quantity calculated in the production quantity calculating step.

Examples of the predetermined duration includes, for example, a design cycle time value of the production equipment.

According to the above configuration and method, time-series data of a physical quantity consumed or generated when production equipment performs a process, is acquired. Then, time-series data of predetermined duration is detected out of the time-series data of the physical quantity. Using the detected time-series data, a production quantity of the production equipment in a specific period is calculated. Thereafter, based on the acquired time-series data of the physical quantity and the production quantity, a physical quantity consumption rate is calculated.

Thus, it becomes possible to calculate a consumption rate of the physical quantity based only on the acquired time-series data of the physical quantity. Thereby, a consumption rate of a physical quantity can be easily calculated without adding another device or modifying a ladder program of a PLC in order to calculate the consumption rate of a physical quantity.

The consumption rate calculator may be constructed by a computer. In such a case, the present invention includes a program that controls the consumption rate calculator configured with a computer that carries out the method to control the consumption rate calculator by performing each of the above steps. Furthermore, the present invention includes a computer-readable recording medium that stores the control program.

[Effects of the Invention]

As described above, a consumption rate calculator according to the present invention is capable of calculating a consumption rate of a physical quantity based only on acquired time series data of the physical quantity. Therefore, the consumption rate of the physical quantity can be easily calculated without adding another device or modifying a ladder program of a PLC to calculate the consumption rate of physical quantity.

Other objects, characteristics, and advantages of the present invention will be fully understood by the description hereinafter. Further, merits of the present invention will be evident from the following descriptions with reference to the accompanying drawings.

### BRIEF DESCRIPTION OF THE DRAWINGS

FIG. 1 A block diagram illustrating a configuration of main components of an operation information outputter according to an embodiment of the present invention.

FIG. 2 An explanatory diagram illustrating a relationship among the operation information outputter, a power meter, and production equipment according to the embodiment.

FIG. 3 Charts illustrating examples of temporal fluctuations in power consumed by the production equipment according to the embodiment.

FIG. 4 A chart illustrating an operation status of a press machine.

FIG. 5 An explanatory diagram illustrating a method employed by a single-cycle detector to detect a single-cycle portion from a waveform of consumed power by use of pattern identification according to the embodiment.

FIG. 6 A diagram illustrating a waveform of consumed power in a case where duration of a single-cycle is different depending on objects to be produced according to the embodiment.

FIG. 7 A flowchart illustrating a process flow, in which the operation information outputter calculates a power consumption rate according to the embodiment.

FIG. 8 A flowchart illustrating a process flow, in which the operation information outputter calculates a power consumption rate for each product type according to the embodiment.

FIG. 9 A diagram illustrating an example of a display screen image showing power consumption rates according to the embodiment.

FIG. 10 A block diagram illustrating a configuration of main components of an operation information outputter according to another embodiment.

FIG. 11 A block diagram illustrating a configuration of main components of an operation information outputter according to another embodiment.

FIG. 12 A block diagram illustrating a schematic configuration of a single-cycle detector and a memory that stores data used by the single-cycle detector according to the embodiment.

FIG. 13 A chart illustrating an example of a frequency spectrum around a reciprocal of a design cycle time value D_{ct}⁻¹, for explaining a method that detects a fundamental frequency according to the embodiment.

FIG. 14 A chart illustrating an example of power data before and after execution of a filtering process by a filtering process executor according to the embodiment.

FIG. 15 A chart illustrating frequency spectrums for the respective power data shown in FIG. 14 according to the embodiment.

FIG. 16 A chart illustrating filtered power data and a second order differential of the filtered power data according to the embodiment.

FIG. 17 A chart used to decide a power threshold value according to the embodiment.

FIG. 18 A flowchart schematically illustrating a processing operation of the single-cycle detector according to the embodiment.

FIG. 19 A block diagram illustrating a schematic configuration of a single-cycle detector and a memory that stores data used by the single-cycle detector according to another embodiment.

FIG. 20 A chart illustrating details of pattern matching according to the embodiment.

FIG. 21 A flowchart schematically illustrating a processing operation of the single-cycle detector according to the embodiment.

FIG. 22 A block diagram illustrating a schematic configuration of the single-cycle detector, a pattern waveform generator, and a memory that stores data used by the single-cycle detector and the pattern waveform generator according to the embodiment.

FIG. 23 A flowchart schematically illustrating a processing operation of the pattern waveform generator according to the embodiment.

FIG. 24 An explanatory diagram illustrating a method for calculating an energy consumption rate in a conventional technology.

### EMBODIMENTS OF THE INVENTION

### First Embodiment

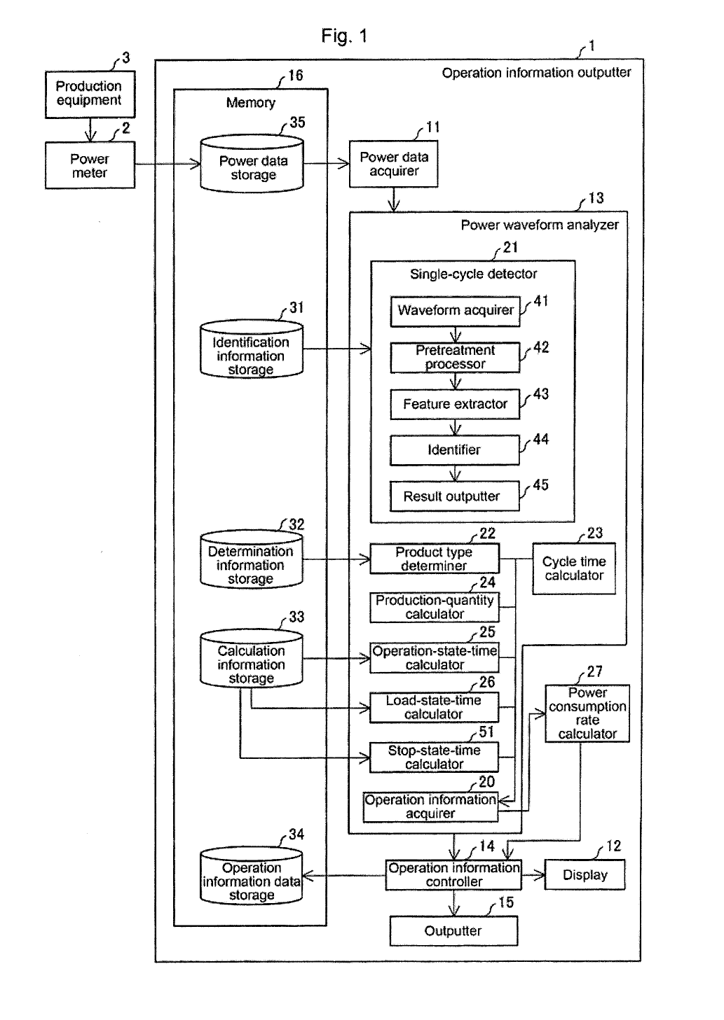

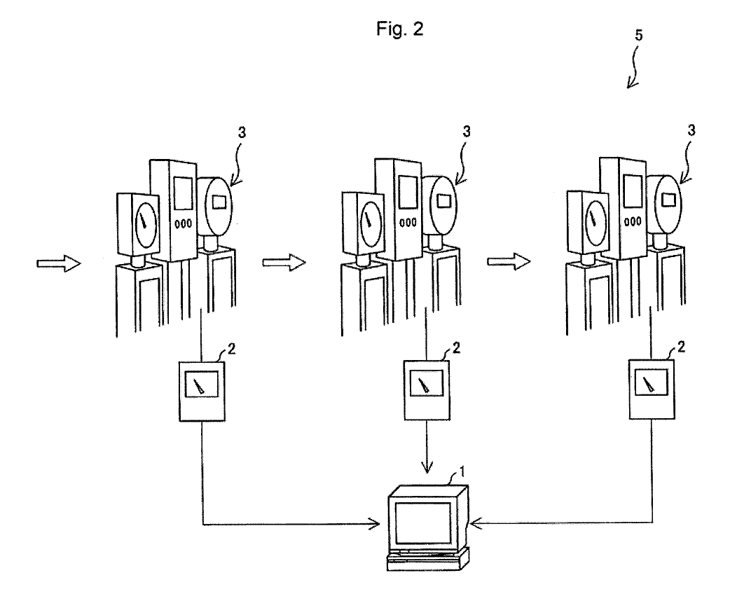

Hereinafter, one embodiment of the present invention is described with reference to the accompanying drawings FIGS. 1 to 9. First, an entire configuration of the present embodiment is schematically described with reference to FIG. 2. FIG. 2 is an explanatory diagram illustrating a relationship among an operation information outputter (consumption rate calculator) 1, power meters 2, and production equipment 3 according to the present embodiment. As shown in FIG. 2, a plurality of production equipment 3 is provided in a production line 5 in the present embodiment. The power meters 2 that measure electric energy provided to each of the plurality of production equipment 3 are connected to the operation information outputter 1. Examples of the production equipment 3 include arbitrary process machines, such as a press machine, an injection molding machine, a washer, and the like.

The operation information outputter 1 analyzes waveforms of power that is consumed by the production equipment 3 and acquired from the power meter 2, and then calculates or determines operation information of the production equipment 3, such as operation-state time, stop-state time, load-state time, a product type, a production quantity, a cycle time, and the like. Further, the operation information outputter 1 calculates a power consumption rate (physical quantity consumption rate) based on the calculated production quantity and total power consumption, and outputs the various calculated or determined information. Thus, the operation information outputter 1 can calculate the power consumption rate based only on power consumption of the production equipment 3 acquired from the power meter 2 while eliminating a necessity of modifying a ladder program of a conventional PLC or introducing a new PLC. Therefore, the power consumption rate can be easily calculated.

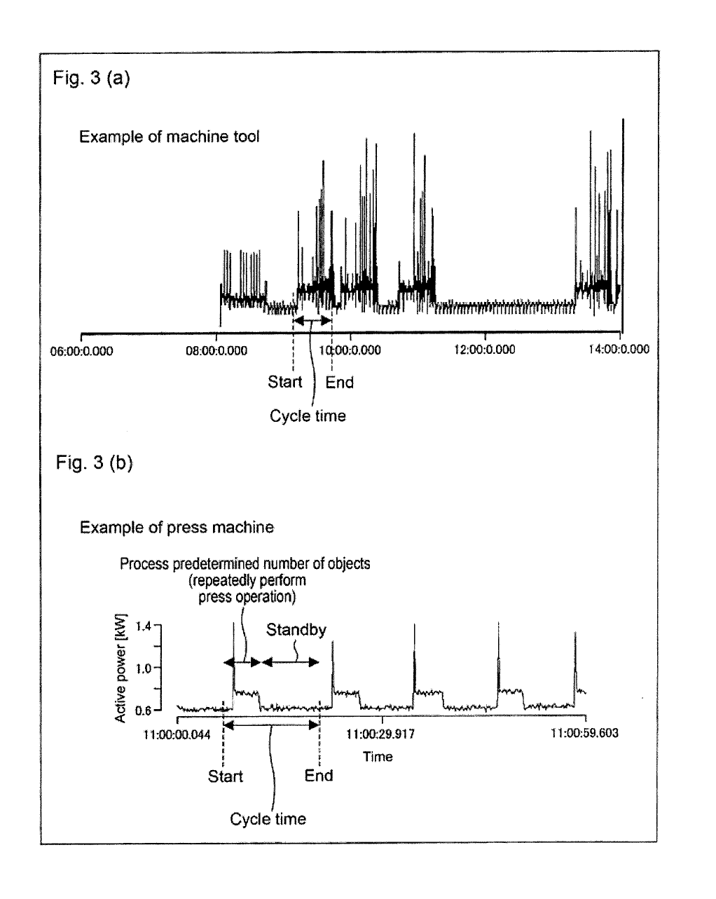

Herein, a cycle time is an amount of time required for one process of repetitive processes, such as a work, a task or a job, and is a unit of frequency or a cycle of the process. FIG. 3 provides charts illustrating examples of temporal fluctuations in power consumed by the production equipment, for showing the cycle time. For example, in a case of a machine tool as shown in FIG. 3(a), a single-cycle is a period from a start to an end of a process on a work (object to be produced).

In a case of a press machine, process time spent to process one work is very short (0.5 ms, for example). As shown in FIG. 3(b), however, when a press operation is repeatedly performed on the predetermined number of products, followed by a predetermined stand-by period, it is possible to consider that a set of the above repetitive press operation and stand-by period is repeatedly performed. Therefore, duration from a start of the press operation to an end of the stand-by period can be regarded as a single-cycle.

A consumption rate is an amount of each production element (raw materials, power, labor, and the like) required to produce a certain amount of products. A power consumption rate is for a case where the production element is consumed power.

The operation information can be used to improve productivity and to reduce energy consumption in the entire production line 5. Furthermore, it is possible to determine the productivity of the production line 5 by use of the power consumption rate.

A configuration of main components of the operation information outputter 1 is described next with reference to FIG. 1. FIG. 1 is a block diagram illustrating the configuration of the main components of the operation information outputter 1 according to the present embodiment. As shown in FIG. 1, the operation information outputter 1 includes a power data acquirer (physical quantity acquirer) 11, a display 12, a power waveform analyzer 13, an operation information controller (display controller) 14, an outputter 15, a memory 16, and a power-consumption-rate calculator 27. The memory 16 includes an identification information storage 31, a determination information storage 32, a calculation information storage 33, an operation information data storage 34, and a power data storage 35.

The identification information storage 31 stores identification information that is used by a single-cycle detector 21, described later, to detect a single-cycle. The identification information includes, for example, waveforms of power consumed by the production equipment 3, or frequency characteristics of a single-cycle of power consumed by the production equipment 3 for each type of objects to be produced in a period from a start to an end of a process (single cycle) on the objects to be produced by the production equipment 3.

The determination information storage 32 stores determination information that is used by a product-type determiner 22, described later, to determine a type of product produced by the production equipment 3. The determination information is a table showing a relationship of the cycle time (time from the start to the end of a process by the production equipment 3 on an object to be produced) and the product type.

The calculation information storage 33 stores calculation information that is used by an operation-state time calculator 25, a load-state-time calculator 26, and a stop-state-time calculator 51, all of which are described later, to calculate an operation-state time, a load-state time, and a stop-state time, respectively. Specifically, the calculation information storage 33 stores a relationship between the power consumption of the production equipment 3 and each of the operation-state time, the load-state time, and the stop-sate time in the production equipment 3.

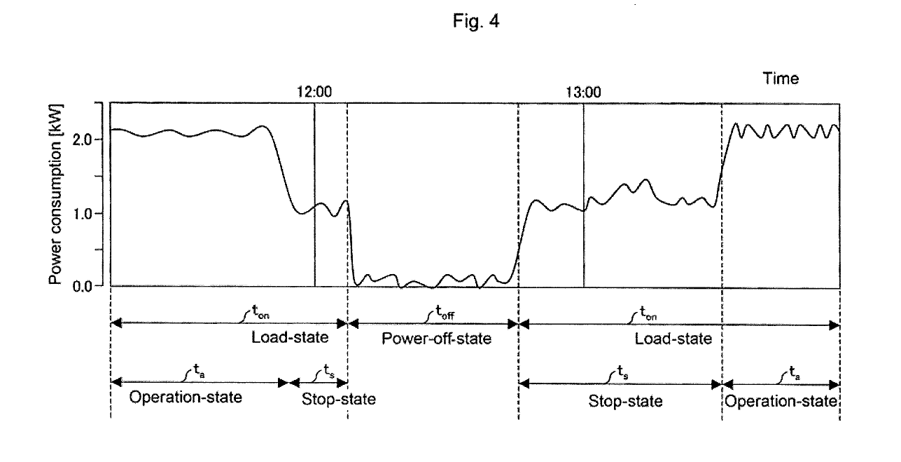

An operation-state, a load-state, and a stop-state are described here, with reference to FIG. 4. FIG. 4 is a chart illustrating an operation status of a press machine. Specifically, FIG. 4 is a graph illustrating a temporal fluctuation in power consumption (kW) consumed by the press machine. FIG. 4 shows a graph that covers several hours. A press machine is used as an example of production equipment in FIG. 4, however, the same can be said for other types of production equipment.

In the graph of FIG. 4, a time t_{off}, in which power consumption is close to 0 kW, is a period when the press machine is in an off-state. This state is referred to as a power-off-state. On the other hand, a time tₒₙ, which is a period except the time t_{off}, is a period when the press machine is in an on-state. This state is referred to as a load-state. A period when the press machine is in the load-state is referred to as a load-state time.

Within the load-state time tₒₙ, a time tₛ, in which power consumption is low, is a period when the press machine is in a stopped state. This state is referred to as a stop-state. The period when the press machine is in the stop-state is referred to as a stop-state time. Examples of causes that create the stop-state include, for example, a breakdown or unexpected malfunction of facilities, a retooling due to a process change (changes of works, jig, or the like), a replacement of a consumable part (cutting tool or the like), a start-up of facilities (warm-up after powering on or the like), a shut-off of facilities (preparation before powering off or the like), and the like.

Within the load-state time tₒₙ, a time tₐ, in which power consumption is high, is a period when the press machine is in an operating state. This state is referred to as an operation-state. A period when the press machine is in the operation-state is referred to as an operation-state time.

An operation information data storage 34 stores operation information calculated or determined by the operation information outputter 1.

A power data storage 35 stores, along with a time stamp, electric energy (total power consumption) that the production equipment 3 has consumed, and power (power consumption) that the production equipment 3 is consuming, the electric energy and the power being measured by the power meter 2.

The power data acquirer 11 acquires power consumption of the production equipment 3 measured by the power meter 2 and stored in the power data storage 35. Specifically, the power data acquirer 11 acquires time-series data, of predetermined duration, of the electric energy (total power consumption) that the production equipment 3 has consumed and the power (power consumption) that the production equipment 3 is consuming. Then, the power data acquirer 11 transmits to a power waveform analyzer 13 the acquired data indicating the power consumption and the total power consumption. The power data acquirer 11 may acquire a value of electric current used by the production equipment 3 at a time of executing a process.

The power waveform analyzer 13 analyzes the time-series data (waveform) of the power consumption acquired from the power data acquirer 11, and calculates or determines the operation information. More specifically, the power waveform analyzer 13 includes the single-cycle detector (data detector) 21, the product-type determiner 22, a cycle-time calculator 23, a production-quantity calculator 24, the operation-state-time calculator 25, the load-state-time calculator 26, the stop-state-time calculator 51, and an operation information acquirer 20. The power waveform analyzer 13 may analyze time-series data of electric current instead of electric energy.

The single-cycle detector 21 detects a single-cycle portion out of the time-series data (waveform) of the power consumption acquired from the power data acquirer 11. More specifically, the single-cycle detector 21 includes a waveform acquirer 41, a pretreatment processor 42, a feature extractor 43, an identifier 44, and a result outputter 45.

The waveform acquirer 41 acquires data of predetermined duration out of the time-series data (waveform) of the power consumption acquired from the power data acquirer 11.

The pretreatment processor 42 removes noise and the like from the waveform of the power consumption of predetermined duration acquired by the waveform acquirer 41.

The feature extractor 43 extracts a predetermined feature from the waveform of the power consumption, from which the pretreatment processor 42 has removed noise and the like.

The identifier 44 determines whether or not the waveform of the power consumption of predetermined duration corresponds to a single-cycle based on the feature extracted by the feature extractor 43 and the identification information stored in the identification information storage 31.

The result outputter 45 outputs a result determined by the identifier 44.

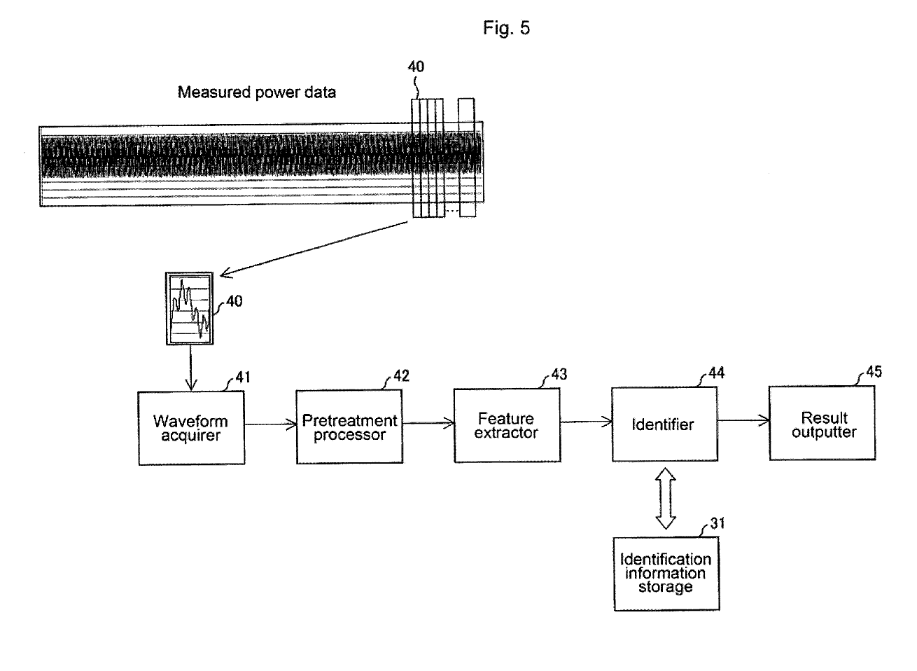

A method, with which the single-cycle detector 21 detects a single-cycle portion out of the time-series data (waveform) of the power consumption acquired by the power data acquirer 11 by use of pattern identification, is described with reference to FIG. 5. FIG. 5 is an explanatory diagram illustrating the method, with which the single-cycle detector 21 detects the single-cycle portion out of the waveform of the power consumption by use of the pattern identification. As shown in FIG. 5, when a single-cycle portion is detected by use of the pattern identification, first, the waveform acquirer 41 acquires a waveform (power pattern 40) of predetermined duration out of the time-series (waveform) power consumption data acquired by the power data acquirer 11. Then, the pretreatment processor 42 removes noise and the like from the power pattern 40. The feature extractor 43 extracts a feature of the power pattern 40 after noise and the like has been removed therefrom. Thereafter, the identifier 44 determines whether or not the power pattern 40 corresponds to a single-cycle by comparing the extracted feature with the feature of the single-cycle stored in the identification information storage 31. Then, the result outputter 45 outputs a result.

A method for detecting a single-cycle portion is not limited to the pattern identification, but a frequency analysis, a template matching, a statistical learning, and a definite total power consumption counting, and the like may be used. Further, these methods may be used in combination.

The frequency analysis is a method that detects a single-cycle portion by use of a frequency feature of a power-consumption waveform. The template matching is a method that detects a single-cycle portion by comparing an acquired waveform with a pre-stored template of a single-cycle waveform. The statistical learning is a method that determines a single-cycle portion by storing and employing characteristics of single-cycle portions in the past. The constant total power consumption counting is a method that determines a single-cycle when total power consumption reaches a predetermined value.

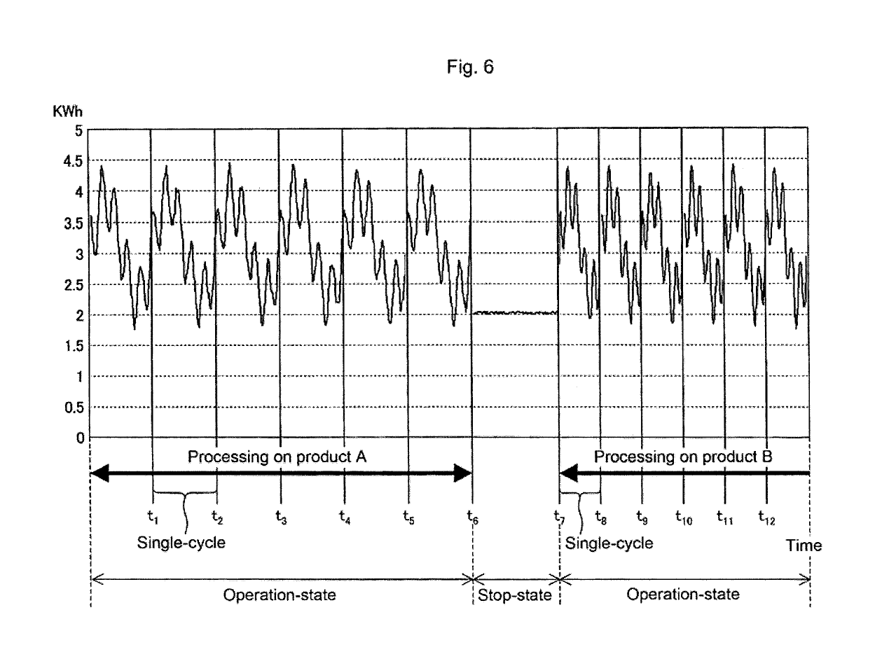

The product-type determiner 22 determines a type of a production object to be produced by the production equipment 3 by using a feature of a single-cycle portion detected by the single-cycle detector 21 and determination information stored in the determination information storage 32. For example, when duration of a single-cycle differs depending on production objects, a type (operation information) of a production object can be determined based on the duration of a single-cycle. This is explained with reference to FIG. 6. FIG. 6 is a diagram illustrating a waveform of power consumption in a case where duration of a single-cycle is different depending on production objects. In FIG. 6, a process is executed on a product A, as a production object, from time 0 to time t6, and a process is executed on a product B, as a production object, at time t7 and onward. An amount of time required for a single-cycle of the process on the product A differs from that of the process on the product B. Therefore, with the amount of time required for a single-cycle for each product being stored as determination information, it is possible to determine a type of a production object based on the stored time of a single-cycle.

The cycle-time calculator 23 calculates duration of a single-cycle (cycle time, operation information) of a power-consumption waveform. The cycle time is calculated based on timing, from which a characteristic point or a characteristic portion repeats in a waveform of power consumption.

The production-quantity calculator 24 calculates the number (production quantity, operation information) of production objects processed by the production equipment 3 within a predetermined period. The production quantity is calculated by counting the number of cycles for a predetermined period. The production quantity within a single-cycle differs depending on each production equipment 3, therefore a coefficient may be given for an adjustment. For example, in a case of the production equipment 3 that produces twelve products in a single-cycle, a calculation may be performed by multiplying with a coefficient 12, as follows:

production quantity=cycle number×12.

The operation-state-time calculator 25 calculates time spent for an operation-state (operation-state time, operation information) within a predetermined period using calculation information stored in the calculation information storage 33. Instead of using the calculation information stored in the calculation information storage 33, the operation-state-time calculator 25 may calculate the operation-state time from the load-state time and the stop-state time calculated by the load-state-time calculator 26 and the stop-state-time calculator 51, respectively.

The load-state-time calculator 26 calculates time spent for a load-state (load-state time, operation information) within a predetermined period using calculation information stored in the calculation information storage 33. Instead of using the calculation information stored in the calculation information storage 33, the load-state-time calculator 26 may calculate the load-state time from the operation-state time and the stop-state time calculated by the operation-state-time calculator 25 and the stop-state-time calculator 51, respectively.

The stop-state-time calculator 51 calculates time spent for a stop-state (stop-state time, operation information) within a predetermined period using calculation information stored in the calculation information storage 33. Instead of using the calculation information stored in the calculation information storage 33, the stop-state-time calculator 51 may calculate the stop-state time from the operation-state time and the load-state time calculated by the operation-state-time calculator 25 and the load-state-time calculator 26, respectively.

The operation information acquirer 20 acquires operation information calculated or determined by each of the product-type determiner 22, the cycle-time calculator 23, the production-quantity calculator 24, the operation-state-time calculator 25, the load-state-time calculator 26, and the stop-state-time calculator 51, and transmits the information to the operation information controller 14 and the power-consumption-rate calculator 27.

The power-consumption-rate calculator 27 calculates total power consumption acquired by the power data acquirer 11. The power-consumption-rate calculator 27 further calculates a power consumption rate based on the calculated total power consumption and the production quantity, the production quantity being calculated by the production-quantity calculator 24 and acquired from the operation information acquirer 20.

The power consumption rate is calculated by

(total power consumption)/(production quantity).

More specifically,

power consumption rate=(total power consumption)/(production quantity calculated by the power waveform analyzer 13).

Thus, a power consumption rate in a load-state including an operation-state and a stop-state can be calculated for a period, in which power consumption is accumulated. Therefore, it is possible to determine a power consumption rate deteriorated by an increase or decrease of power consumption during a period when no production operation is performed (time in a stop-state, for example), such as a standby period. Alternatively, of total power consumption, only the electric energy actually used for a process may be used to calculate a power consumption rate. Thereby, it is possible to calculate a power consumption rate only for a period when a process is executed. A total power consumption of an operation-state time may be used as the electric energy actually used for a process. Alternatively, the electric energy actually used for a process may be calculated by

(total power consumption for a single-cycle)×(production quantity).

Further, it is possible to calculate ideal total power consumption by

(ideal total power consumption for a single-cycle)×(production quantity).

By calculating a power consumption rate using the above, it is possible to calculate the ideal power consumption rate. Further, by calculating an actual power consumption rate while using the calculated ideal power consumption rate as a reference, it is possible to understand how much disparity exists between an actual condition and an ideal condition.

In addition, a power consumption rate per time or per date may be calculated. Further, a variance, a standard deviation, a maximum value, a minimum value, and the like for the calculated power consumption rate may be computed. With a variance and a standard deviation being calculated, it is possible to grasp a level of dispersity of the power consumption rate. Knowing the dispersity level helps to understand at what time (date) a power consumption rate is extremely high or low, thereby making it possible to improve productivity. Also, calculating a maximum value and a minimum value provides the same effect.

The operation information controller 14 acquires, from the operation information acquirer 20, operation information calculated and determined by the power waveform analyzer 13, and causes the operation information data storage 34 to store operation information data. The operation information controller 14 further transmits data indicating the operation information to the outputter 15 in a case where the operation information is transmitted to an external device. The operation information controller 14 further causes the display 12 to display the operation information. The operation information controller 14 causes the operation information data storage 34 to store a calculation result of a power consumption rate acquired from the power-consumption-rate calculator 27, in the same way as that for the operation information. The operation information controller 14 further causes the display 12 to display the calculation result. Furthermore, the operation information controller 14 transmits data indicating a calculation result of the power consumption rate in a case where the calculation result of the power consumption rate is transmitted to an external device.

The display 12 is a displaying device to display information, such as operation information and the like, acquired from the operation information controller 14.

The outputter 15 outputs operation information acquired from the operation information controller 14 to an external device in a case where the operation information is transmitted to an external device.

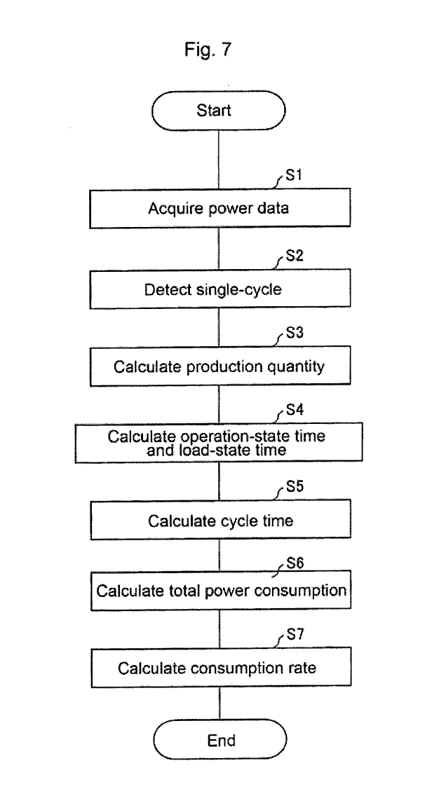

A process flow for calculating and determining operation information in the operation information outputter 1 is described next with reference to FIG. 7. FIG. 7 is a flowchart illustrating a process flow, in which the operation information outputter 1 calculates and determines operation information.

As shown in FIG. 7, the power data acquirer 11 acquires time-series power data for the period from a time of previous power data acquisition to a present time (S1). Next, the single-cycle detector 21 detects a single-cycle from the time-series power data acquired by the power data acquirer 11 (S2). Then, the production-quantity calculator 24 calculates the number of production objects, on which the production equipment 3 has executed a process for a period indicated by the time-series power data acquired by the power data acquirer 11 (S3).

The operation-state-time calculator 25 calculates duration of an operation-state in the production equipment 3 within the period indicated by the time-series power data acquired by the power data acquirer 11; and the load-state-time calculator 26 calculates duration of a load-state in the production equipment 3 within the same period (S4). Then, the cycle-time calculator 23 calculates a cycle time (S5).

Thereafter, the power-consumption-rate calculator 27 calculates total power consumption acquired by the power data acquirer 11 (S6). Then, the power-consumption-rate calculator 27 calculates a power consumption rate based on the calculated total power consumption and the production quantity calculated by the production-quantity calculator 24 (S7). This is the end of the process flow.

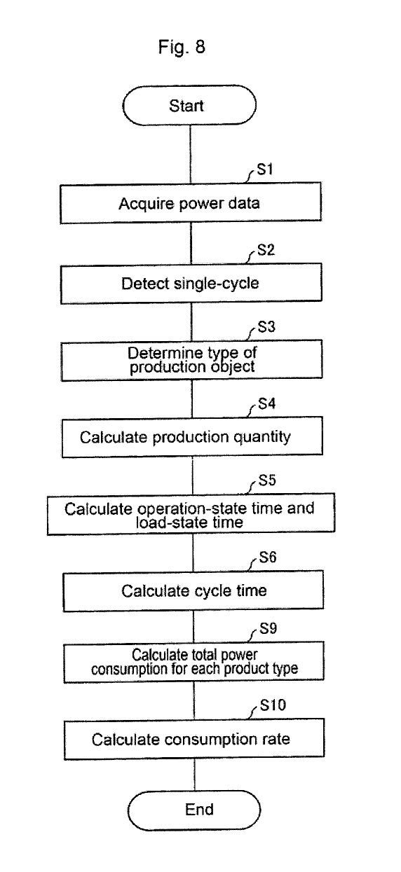

The total power consumption may be calculated for each type of production objects, on which a process is executed. A process flow in such a case is explained with reference to FIG. 8. FIG. 8 is a flowchart illustrating a process flow in a case where a power consumption rate is calculated for each type of production objects being processed.

Descriptions of the portions similar to those in FIG. 7 is omitted. After detecting a single-cycle in step S2, the product-type determiner 22 determines a type of objects to be produced by the production equipment 3 (S3). After a cycle time is calculated in step S6, the power-consumption-rate calculator 27 calculates total power consumption for each product type based on the electric energy acquired by the power data acquirer 11 and the product type determined by the product-type determiner 22 (S9). The power-consumption-rate calculator 27 calculates a power consumption rate based on the calculated total power consumption for each product type and the production quantity calculated by the production-quantity calculator 24 (S10).

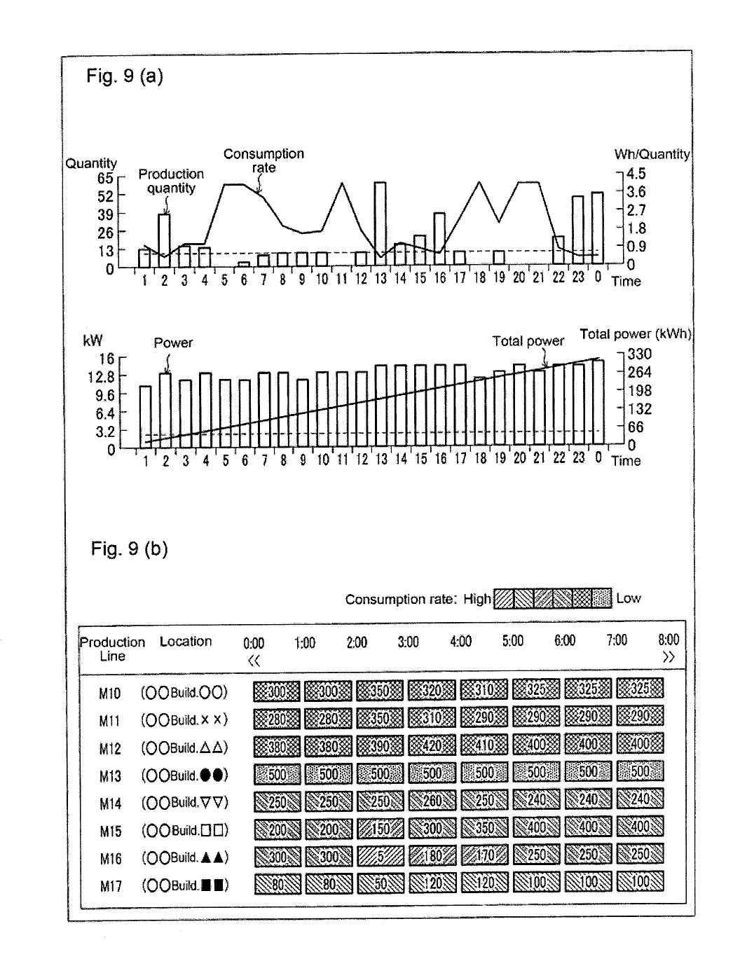

Next, descriptions is provided about examples of a display screen image in a case where a calculated consumption rate is displayed on the display 12, with reference to FIG. 9. FIGS. 9(a) and (b) each illustrate an example of a display screen image in a case where information including a consumption rate is displayed. In the upper half of FIG. 9(a), a horizontal axis indicates time, and a vertical axis indicates production quantity and power consumption rate. In the lower half of FIG. 9(a), a horizontal axis indicates time, and a vertical axis indicates power consumption and total power consumption.

In the upper half of FIG. 9(a), a bar graph shows production quantities, and a line graph shows electric power consumption rates. The example in the upper half shows that the electric power consumption rates deteriorate at 5 o'clock, 11 o'clock, 18 o'clock, and 21 o'clock. The lower half shows power consumption and total power consumption for separate two production lines.

In the example shown in FIG. 9(b), a horizontal axis shows time, and a vertical axis is a line-by line display showing power consumption rates in numbers for each production line for each time. This allows a user to easily understand a level of the power consumption rates. Further, by displaying different levels in different colors (a color map) along with numbers, a user can easily understand the level of the electric power consumption rates.

With the color map, a user can quickly survey statuses of consumption rates in all production lines. Therefore, a user can overview entire status without checking status of each consumption rate for each production line, thereby making it possible to easily recognize which production line has a deteriorating consumption rate.

In FIG. 9, power consumption rates are displayed for production lines, however, power consumption rates may be displayed for each of the production equipment 3. Further, a power consumption rate of one production line can be calculated by accumulating power consumption rates of the production equipment 3 included in the production line.

### Second Embodiment

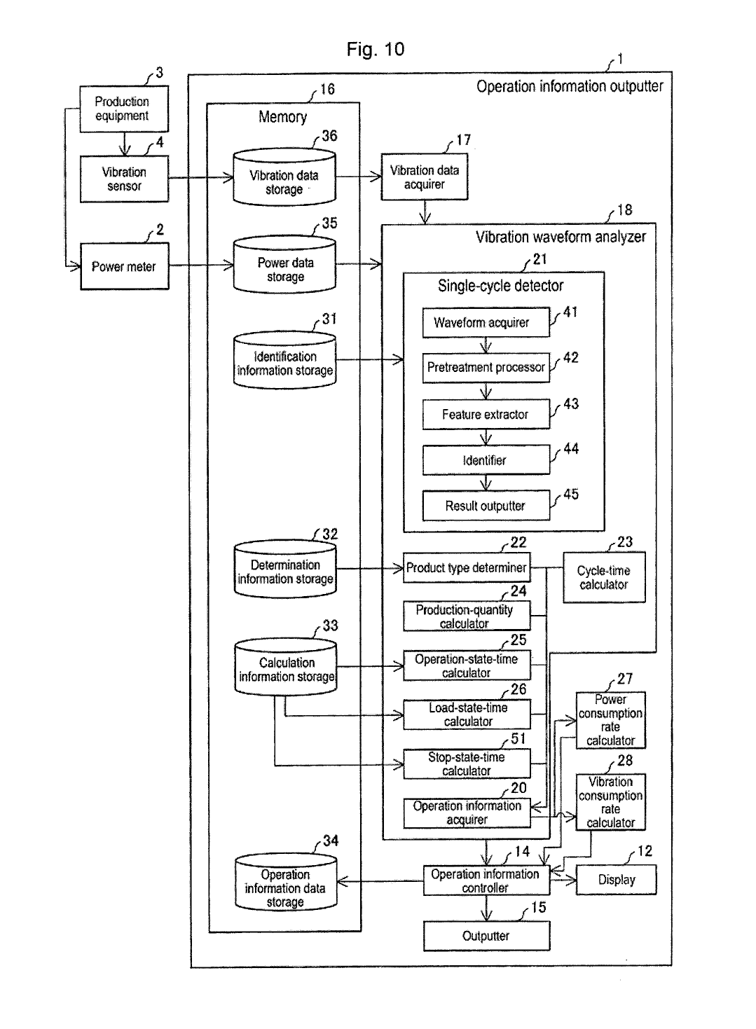

Hereinafter, another embodiment of the present invention is described with reference to FIG. 10. As a matter of convenience for a description, components having the same features as those shown in the above embodiment are provided with the same numerical references, and illustration thereof is omitted.

FIG. 10 is a block diagram illustrating a configuration of main components of an operation information outputter 1 according to the present embodiment.

The present embodiment differs from the first embodiment in that, instead of the time-series power data, time-series vibration data is used to calculate and determine operation information; and in that a vibration consumption rate is calculated, the time-series vibration data being an amount of vibration that fluctuates in a specific portion of the production equipment 3, and the vibration consumption rate being an energy consumption rate of the vibration. Thus, the present embodiment is provided with a vibration sensor 4 to the production equipment 3, a vibration data storage 36 to the memory 16, and a vibration data acquirer (physical quantity acquirer) 17. Further, the present embodiment is provided with a vibration waveform analyzer 18 instead of the power waveform analyzer 13, and a vibration-consumption-rate calculator (consumption rate calculator) 28.

The vibration data storage 36 stores vibration data transmitted from the vibration sensor 4.

The vibration sensor 4 is a sensor that detects vibration. The vibration sensor 4 detects vibration of the production equipment 3 and causes the vibration data storage 36 to store vibration data indicating the detected vibration.

The vibration data acquirer 17 acquires time-series vibration data stored in the vibration data storage 36, and transmits the data to the vibration waveform analyzer 18.

The vibration waveform analyzer 18 analyzes the time-series vibration data (waveform) acquired from the vibration data acquirer 17, and calculates and determines operation information of the production equipment 3. Within the specific configuration of the vibration waveform analyzer 18, illustration is omitted for components similar to the power waveform analyzer 13. Time-series vibration data for the vibration waveform analyzer 18 corresponds to the time-series power data for the power waveform analyzer 13.

The vibration-consumption-rate calculator 28 calculates a vibration consumption rate based on vibration data acquired by the vibration data acquirer 17, and a production quantity calculated by the production-quantity calculator 24 and acquired from the operation information acquirer 20. Specifically, total vibration energy is calculated from the vibration data acquired by the vibration data acquirer 17, and then the vibration consumption rate is calculated as follows:

vibration consumption rate=(total amount of vibration energy)/(production quantity calculated by the vibration waveform analyzer 18)

In the above description, the vibration sensor 4 is used to acquire time-series data, however, a configuration is not limited to this. Time-series data acquired by a flow sensor, a temperature sensor, a humidity sensor, a sound sensor, an image sensor, a proximity sensor, a photoelectric sensor, and the like, may be used to detect a single-cycle, and then to calculate or determine operation information.

The production-quantity calculator 24 calculates a production quantity based on the number of cycles included in vibration data acquired by the vibration data acquirer 17.

Further, each of the above sensors may be used in combination with a power meter to detect a single-cycle, and then to calculated and determine operation information.

The present embodiment is configured to calculate a power consumption rate and a vibration consumption rate. In a case where it is not necessary to calculate a power consumption rate, however, the power-consumption-rate calculator 27 may be absent.

The power-consumption-rate calculator 27 may include a power waveform analyzer 13 and calculates a power consumption rate using a production quantity calculated by the power waveform analyzer 13. In other words, in a case where the power-consumption-rate calculator 27 includes the power waveform analyzer 13 and the vibration waveform analyzer 18, the power-consumption-rate calculator 27 may calculate a power consumption rate using a production quantity calculated by the power waveform analyzer 13, or may calculate a power consumption rate using a production quantity calculated by the vibration waveform analyzer 18. Specifically, a power consumption rate may be calculated as follows:

power consumption rate=(total power consumption)/(production quantity computed by the vibration waveform analyzer 18).

The vibration-consumption-rate calculator 28 may calculate a vibration consumption rate using a production quantity calculated by the power waveform analyzer 13. In other words, in a case where the vibration-consumption-rate calculator 28 includes the power waveform analyzer 13 and the vibration waveform analyzer 18, the vibration-consumption-rate calculator 28 may calculate a vibration consumption rate using the production quantity calculated by the power waveform analyzer 13, or may calculate the vibration consumption rate using the production quantity calculated by the vibration waveform analyzer 18. Specifically, a vibration consumption rate may be calculated as follows:

vibration consumption rate=(total vibration energy)/production quantity calculated by the power waveform analyzer 13).

### Third Embodiment

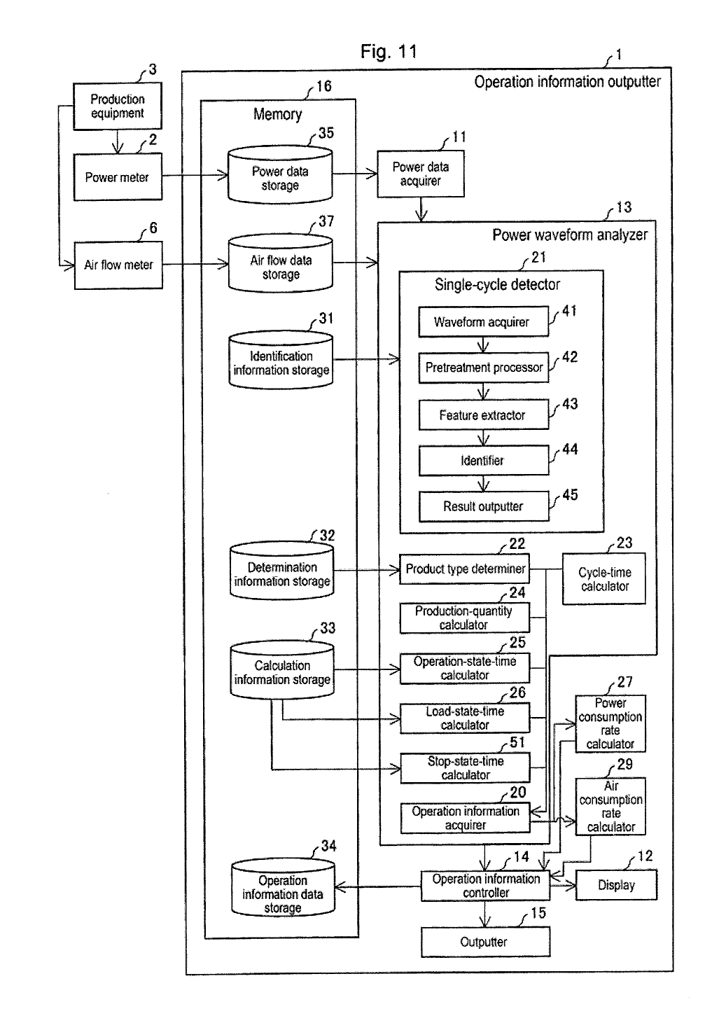

Hereinafter, another embodiment of the present invention is described with reference to FIG. 11. As a matter of convenience for a description, components having the same functions as those shown in the first embodiment are provided with the same numerical references, and illustration thereof is omitted. FIG. 11 is a block diagram illustrating a configuration of main components of an operation information outputter 1 according to the present embodiment.

The present embodiment differs from the first embodiment in that the production equipment 3 has an air flow meter 6; in that air flow data is acquired; and in that an air consumption rate is calculated, the air consumption rate being a consumption rate of an air flow amount. Thus, in the present embodiment, the production equipment 3 includes the air flow meter 6, and the memory 16 includes an air flow data storage 37. In addition, an air-consumption-rate calculator 29 (consumption rate calculator) is provided in the present embodiment.

The air flow meter 6 measures an amount of air flow, and measures an amount of air (compressed air) used when the production equipment 3 executes a process.

The air flow data storage 37 stores a flow amount data transmitted from the air flow meter 6.

The air-consumption-rate calculator 29 calculates an air consumption rate based on an amount of air flow stored in the air flow data storage 37 and a production quantity calculated by the production-quantity calculator 24 and acquired from the operation information acquirer 20. Specifically, an air consumption rate is calculated as follows:

air consumption rate=(total air amount)/(production quantity calculated by the power waveform analyzer 13).

The air-consumption-rate calculator 29 may include the vibration waveform analyzer 18 and calculate an air consumption rate using the production quantity computed by the vibration waveform analyzer 18. Specifically, an air consumption rate may be calculated as follows:

air consumption rate=(total air amount)/(production quantity calculated by the vibration waveform analyzer 18).

### Fourth Embodiment

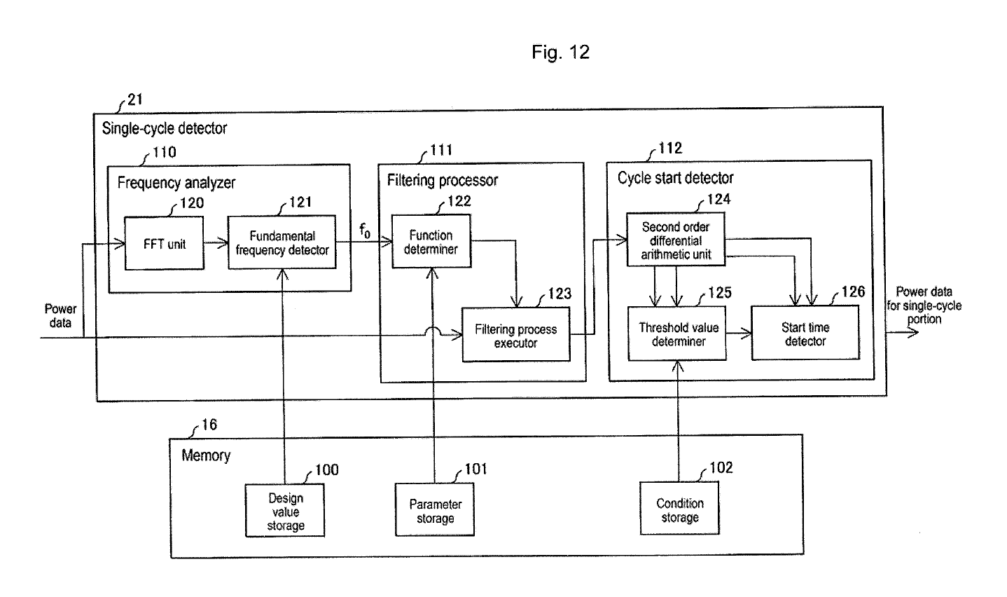

Next, another embodiment of the present embodiment is explained with reference to FIGS. 12 to 18. Compared with the operation information outputter 1 shown in FIGS. 1 to 11, an operation information outputter 1 of the present embodiment is different in terms of an operation of a single-cycle detector 21. Components having the same functions as those described in the above embodiments are provided with the same numerical references, and illustration thereof is omitted.

The single-cycle detector 21 of the present embodiment employs a design cycle time value D_{ct} and a frequency analysis to detect a starting point of a single-cycle of power data so as to detect power data for a single-cycle. Herein, the design cycle time value D_{ct} is a design value of a cycle time set by a responsible person in a manufacturing floor, or the like.

FIG. 12 illustrates a schematic configuration of the single-cycle detector 21 and the memory 16 that stores data used by the single-cycle detector 21. As shown in FIG. 12, the single-cycle detector 21 includes a frequency analyzer 110, a filtering processor 111, and a cycle start detector 112. The memory 16 includes a design value storage 100, a parameter storage 101, and a condition storage 102.

The design value storage 100 stores the design cycle time values D_{ct}. The parameter storage 101 stores values of various parameters used by the filtering processor 111 for a filtering process. The condition storage 102 stores various conditions used to detect a stat point of a single-cycle. The design cycle time value D_{ct}, the above-described various parameters, and the above-described conditions are pre-stored in the design value storage 100, the parameter storage 101, and the condition storage 102, respectively, through an input unit (not shown) or the like.

The frequency analyzer 110 analyzes a frequency of power data and detects a fundamental frequency f₀ of a periodic waveform using the design cycle time value D_{ct}. The frequency analyzer 110 includes an FFT unit 120 and a fundamental frequency detector 121.

The FFT unit 120 performs an FFT with respect to power data of predetermined duration. The FFT unit 120 transmits, to the fundamental frequency detector 121, data of frequency spectrum after FFT is performed. The above-described predetermined duration may be any duration as long as later-described various statistical values can be acquired from the power data. An example includes a time tₐ, in which an operation-state continues for a period longer than several times of the design cycle time value D_{ct}.

The fundamental frequency detector 121 detects the fundamental frequency f₀ of a periodic waveform using the frequency spectrum data output from the FFT unit 120. The fundamental frequency detector 121 transmits the detected fundamental frequency f₀ to the filtering processor 111.

In the present embodiment, a range of frequency, in which the above-described fundamental frequency is detected, is limited to a predetermined range including a reciprocal of a design cycle time value D_{ct}⁻¹ stored in the design value storage 100. Thus, it is possible to successfully acquire a fundamental frequency of a periodic waveform corresponding to a cycle time.

FIG. 13 illustrates a method that detects the fundamental frequency, and shows an example of a frequency spectrum around the reciprocal of design cycle time value D_{ct}⁻¹ as a line graph. In FIG. 13, a range between broken lines is the above-described predetermined range. The fundamental frequency detector 121 detects a frequency having a strongest frequency spectrum in the range between the broken lines as a fundamental frequency f₀. In the present embodiment, the frequency in the above-described predetermined range is 0.5 to 2 times of the reciprocal of the design cycle time value D_{ct}⁻¹.

The filtering processor 111 performs a filtering process (filtering) on the power data so as to emphasize a frequency element around the fundamental frequency f₀. The filtering process 111 includes a function determiner 122 and a filtering process executor 123.

The function determiner 122 uses the fundamental frequency f₀ output from the fundamental frequency detector 121, and determines a filtering function that is a function used for a filtering process. The function determiner 122 transmits, to the filtering process executor 123, information of the determined filtering function.

The present embodiment uses a following logistic function f(x) as a filtering function. It is also possible to use other functions as a filtering function.

f(x)=1/(1+exp(s×(x−fc)))

Herein, fc indicates a value of x when f=0.5, and corresponds to a cutoff frequency in the present embodiment. Further, in the present embodiment, the cutoff frequency is defined as follows:

cutoff frequency fc=fundamental frequency f₀×a parameter Pₐᵣₐₘ.

Further, “s” indicates a reduction rate of the logistic function, and is provided in a range 0≦s≦.

The filtering process executor 123 uses the filtering function output from the function determiner 122, and executes a filtering process on power data. The filtering process executor 123 transmits the filtered power data to the cycle start detector 112.

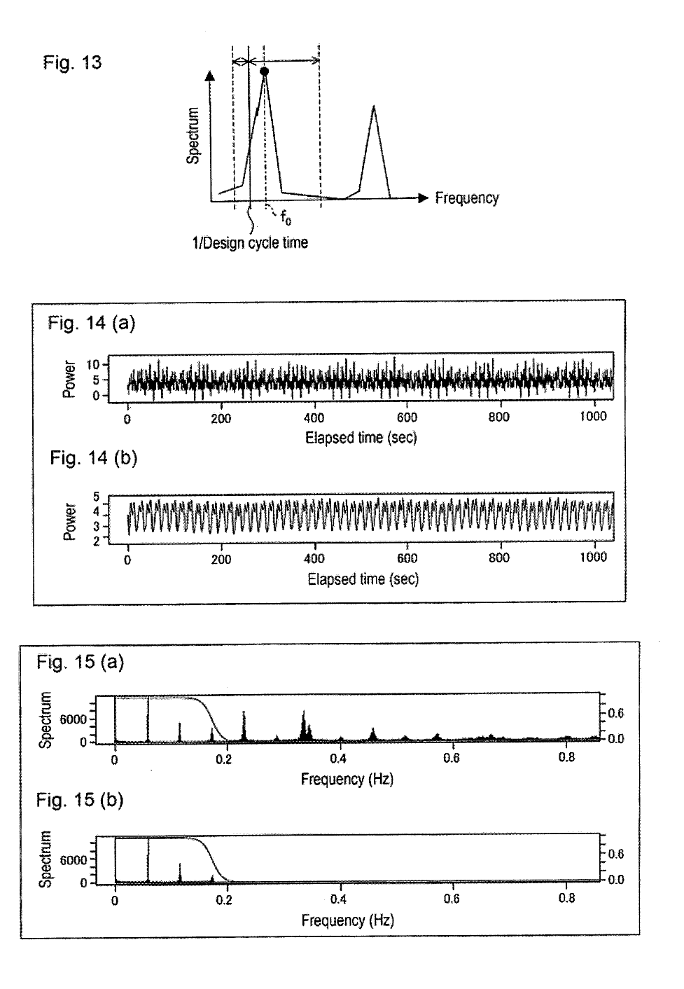

FIGS. 14 (a) and (b) are charts each illustrating an example of power data before and after an execution of a filtering process by the filtering process executor 123. FIGS. 15 (a) and (b) are charts each illustrating frequency spectrums for the respective power data shown in FIG. 14 (a) and (b).

FIGS. 15 (a) and (b) illustrate frequency characteristics of a logistic function, which is a filtering function, determined by the function determiner 122. In the illustrated example, f₀≈0.0573 Hz, Pₐᵣₐₘ=3 (hence, fc=0.1719 Hz), s=0.1. In addition, FIGS. 14 and 15 illustrate examples of a case where the production equipment 3 is an injection molding machine.

A comparison between FIGS. 15 (a) and (b) shows that an execution of the filtering process removes frequency components higher than the fundamental frequency f₀ and also higher than or equal to 0.2 Hz. In addition, a comparison between FIGS. 14 (a) and (b) shows that an execution of the filtering process makes a cycle waveform more distinctive.

The cycle start detector 112 detects the starting point of a single-cycle. When the production equipment 3 starts a process on a work, power consumption often suddenly increases. In fact, in referring to the power data after the above filtering process shown in FIG. 14 (b), it is understood that a rise, that is, a sudden increase of a power value, occurs periodically.

Thus, when a rise of the power value after the filtering process can be detected, it is possible to detect a starting point of a single-cycle. In the present embodiment, the rise of the power value is used as a starting point of a single-cycle.

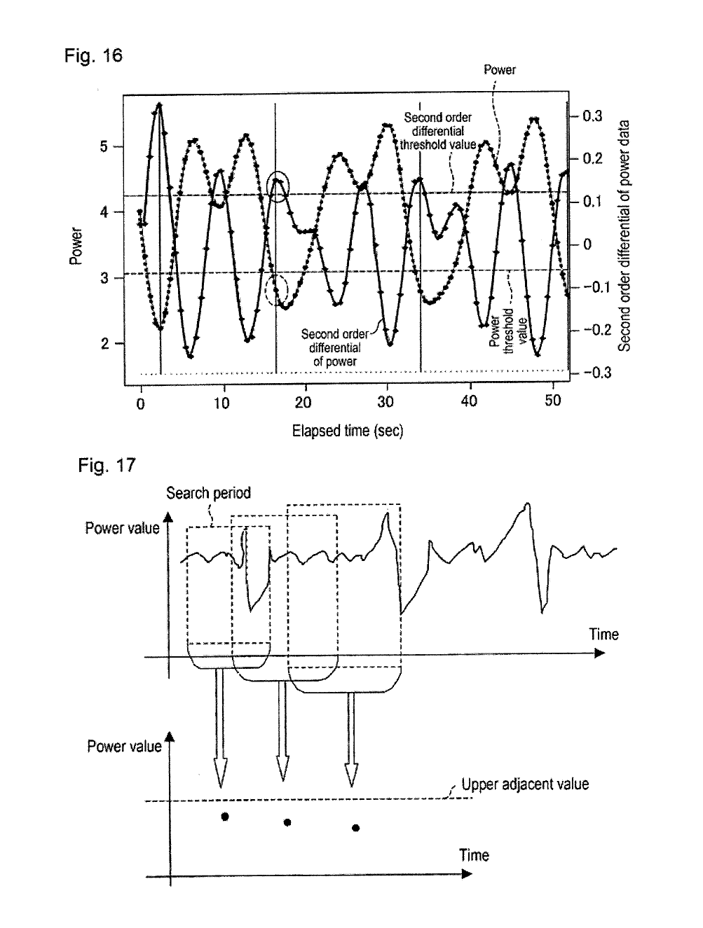

Various techniques are known as a method for determining the rise of the power value. A detection method used in the present embodiment is described with reference to FIG. 16. FIG. 16 is a chart illustrating a power data after the filtering process and second order differential of the power data. In the chart, a solid line is a graph of the power data, and a dashed line is a graph of the second order differential of the power data.

As shown in FIG. 16, a power value after the filtering process is small immediately before the rise thereof. Then, the slope of the power value sharply increases from negative to positive as time passing by. Thus, the second order differential value of the power value becomes large. Thus, it is possible to determine a rising point of the power value when the following condition is met, the condition being that the power value is less than a predetermined threshold value and the second order differential value of the power value is greater than another threshold value. For example, in FIG. 16, the locations enclosed by circles in the same line types as those of the graph lines meet the above condition. Thus, those locations are determined as rising points of the power value. Hereinafter, the above threshold value for the power value is referred to as a “power threshold value”, and the above threshold value for the second order differential value of the power value is referred to as a “second order differential threshold value”. Further, the above condition is referred to as a “rise detection condition”.

Furthermore, additional requirements may be added to the rise detection condition. For example, even when the slope of the power value sharply increases as described above, in a case where the slope of the power value decreases immediately after that, the increase in the power value is suppressed. Thus, a rise cannot be determined. Therefore, the rise detection condition may further include another requirement, such that the power value after a predetermined time period (e.g., five second) from the time of meeting the above condition is greater than the power threshold value.

In addition, as shown in FIG. 16, it is possible that the rise detection condition may be satisfied not only at one point in time, but also multiple points in time including the first point in time. Therefore, there may be a case where the above rise detection condition is satisfied at a plurality of points in time within a period equal to or shorter than 0.5 times of either one of the design cycle time value D_{ct} and the fundamental period T₀, which is a reciprocal of the fundamental frequency f₀. In such a case, the rise detection condition may further include a requirement, such that a rising point of the power value is determined at a point in time when the second order differential value of the power value is the greatest.

Next, a method for determining the power threshold value and the second order differential threshold value is described. In referring to FIG. 16, it is understood that power values need to periodically fall under the power threshold value. Therefore, a power threshold value is determined so as to be a value that can detect the power values that periodically fall under the power threshold value.

FIG. 17 is a chart used to decide a power threshold value. In the upper part in FIG. 17, a graph indicates a temporal fluctuation in power data, and the dashed lines each indicate search periods. In the lower part in FIG. 17, medians of the predetermined number of lowest power values of the power data in each search period are shown.

As the above-mentioned predetermined number, actual number may be employed, or a formula that obtains the predetermined number may be employed. Examples of such a formula include, for example, the formula as follows:

a predetermined number=a/(f₀* t_{sampling}) (where the figure below the decimal point is rounded up)

Herein, “t_{sampling}” represents a sampling period of data measurement. Also, “(f₀* t_{sampling})⁻¹” represents the number of data for the fundamental period T₀ (=1/f₀), and “a” represents its coefficient. In the present example, “a”=0.3. For example, in a case where f₀=0.1719 Hz, and t_{sampling}=0.6 second, it is determined that the predetermined number =3. Therefore, the medians of the lowest three power values are calculated.

As shown in FIG. 17, in the present embodiment, a predetermined search period is set to be a certain time period on the upstream side. The median values are calculated for the predetermined number of the lowest power values within the power data included in the set search period. It is preferable that the above search period has predetermined duration longer than the fundamental period T₀.

Next, the same process as described above is repeatedly performed while shifting the search period by a predetermined length of time to the downstream side. Then, an upper adjacent value of a set of the calculated median values is determined as the power threshold value. It is desirable that the predetermined length of time be shorter than the fundamental period T₀ and, more preferably, about a half of the fundamental period T₀.

Herein, the upper adjacent value is a maximum value of data below a point, which is an upper hinge U+(H-spread h×a). The H-spread h is a distance between an upper hinge U and a lower hinge. The upper hinge is a median of data above a median of all data (75th percentile value). The lower hinge is a median of data below a median of all data (25th percentile value). The parameter “a”, which typically is 1.5, is 2 in this embodiment, considering the margin to successfully detect a rise.

The second order differential threshold value can be determined by use of an approach opposite to the method for determining the power threshold value. Specifically, in referring to FIG. 16, it is understood that the power values need to periodically exceed the second order differential threshold value. Thus, a second order differential threshold value is determined so as to be a value that can periodically detect the power values that exceed the second order differential threshold value.

In the present embodiment, a predetermined search period is set to be a certain time period on the upstream side. The median values are calculated for the predetermined number of the highest power values within the second order differential data included in the set search period. Next, the same process as described above is repeatedly performed while shifting the search period by a predetermined length of time to the downstream side. Then, a lower adjacent value of a set of the calculated median values is determined as the second order differential threshold value. Herein, the lower adjacent value is a minimum value of data above a point, which is a lower hinge L−(H-spread h×a).

Therefore, the cycle start detector 112 determines a rise of a power value as a starting point of a single-cycle by use of power data, on which the filtering process executor 123 has performed a filtering process, and a second order differential of the power data. The cycle start detector 112 includes a second order differential arithmetic unit 124, a threshold value determiner 125, and a start time detector 126. Further, the condition storage 102 stores the above search period, the above predetermined number, the above predetermined length of time, and the parameter “a”.

The second order differential arithmetic unit 124 calculates a second order differential of the filtered power data output from the filtering process executor 123. The second order differential arithmetic unit 124 transmits, to the threshold value determiner 125 and the start time detector 126, the calculated second order differential data along with the filtered power data.

The threshold value determiner 125 determines the power threshold value and the second order differential threshold value as described above, by use of the filtered power data and the second order differential data output from the second order differential arithmetic unit 124, and the search period, the predetermined number, the predetermined length of time, and the parameter “a” stored in the condition storage 102. The threshold value determiner 125 transmits, to the start time detector 126, the determined power threshold value and second order differential threshold value.

The start time detector 126 detects a starting point of a single-cycle by use of the filtered power data and the second order differential data from the second order differential arithmetic unit 124, and the power threshold value and the second order differential threshold value from the threshold value determiner 125, based on the above-described rise detection condition. Thereby, the single-cycle detector 21 can detect power data for a single-cycle portion.

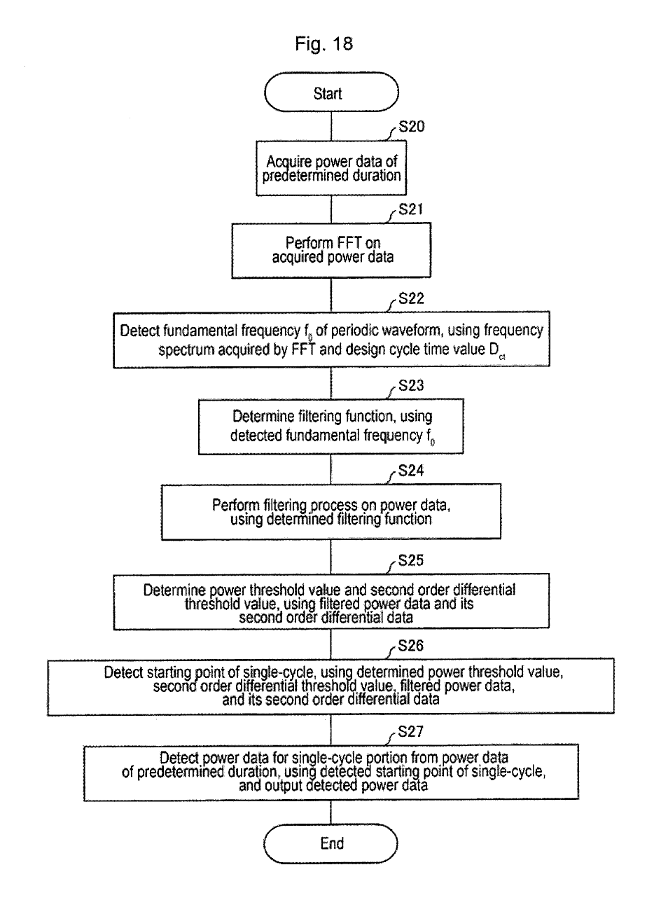

Next, a processing operation of the single-cycle detector 21 in the operation information outputter 1 having the above configuration is described with reference to FIG. 18. FIG. 18 schematically illustrates a processing operation of the single-cycle detector 21.

As shown in FIG. 18, the single-cycle detector 21 first acquires power data of predetermined duration from the power data storage 35 (S20). Next, the FFT unit 120 performs an FFT on the acquired power data (S21). The fundamental frequency detector 121 detects a fundamental frequency f₀ of a periodic waveform, by use of a frequency spectrum data acquired by performing the FFT and the design cycle time value D_{ct} stored in the design value storage 100 (S22).

Next, the function determiner 122 determines a filtering function by use of the detected fundamental frequency fₒ and various parameters stored in the parameter storage 101 (S23). The filtering process executor 123 performs a filtering process on the power data by use of the determined filtering function (S24).

Next, the second order differential arithmetic unit 124 calculates a second order differential of the filtered power data; and then the threshold value determiner 125 determines a power threshold value and a second order differential threshold value by use of the second order differential data acquired from the calculation result, the filtered power data, and various data stored in the condition storage 102 (S25). Next, the start time detector 126 detects, based on the rise detection condition, a starting point of a single-cycle by use of the determined power threshold value and the second order differential threshold value, the filtered power data, and the second order differential data (S26). Then, the single-cycle detector 21 detects power data for a single-cycle portion out of the power data of predetermined duration acquired from the power data storage 30, by use of the detected starting point of the single-cycle, and outputs the detected power data (S27). Thereafter, the processing operation is completed.

The present embodiment detects a starting point of a single-cycle by use of power data and various set values. Thus, it is not necessary to use a pattern waveform.

The present embodiment determines a rising point of a power value as a starting point of a single-cycle. However, some of the production equipment 3 may start the manufacturing process after preparing for the manufacturing process. In this case, the starting point of a single-cycle is a starting point of the preparation. Thus, the starting point of the manufacturing process deviates from the rising point of the power value. In many cases, however, the preparation period may be already known based on the operation of the production equipment 3, or power data of the preparation period may show a specific characteristic. Therefore, by detecting the rising point of the power value, the starting point of the preparation, that is, the starting point of the single-cycle, can be easily acquired.

Similar to the detection of a rising point of a power value, a fall point of the power value may be detected. In this case, a period from a rise of a power value to a fall of a power value is a net operation-state time tₐᵥ(see FIG. 4), and thus an added value creation period can be acquired.

### Fifth Embodiment

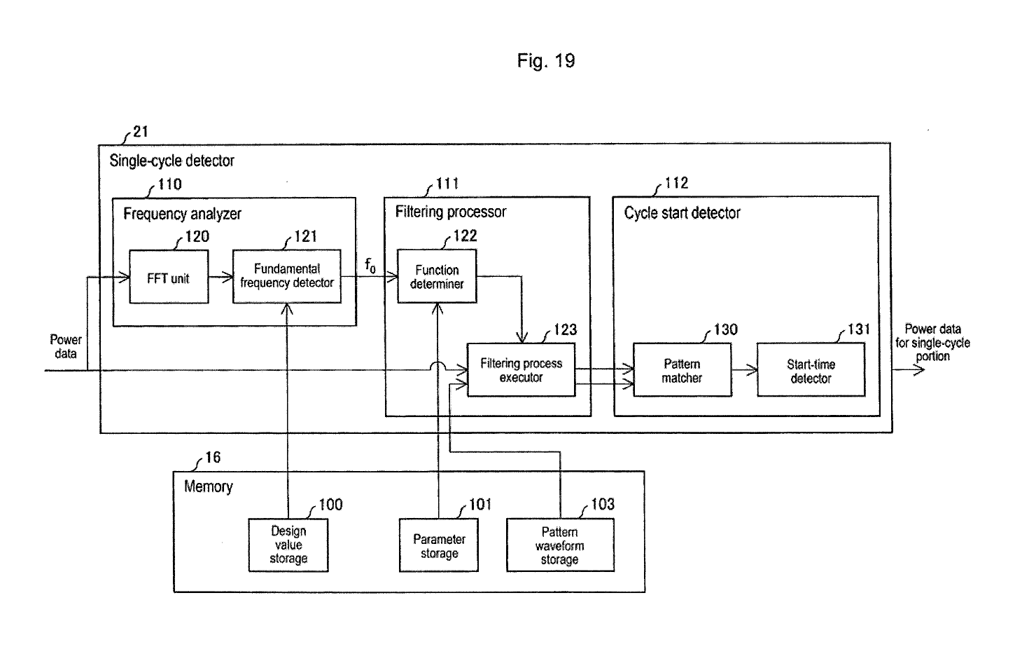

Next, another embodiment of the present invention is described with reference to FIGS. 19 to 21. FIG. 19 illustrates a schematic configuration of an single-cycle detector 21 included in a power waveform analyzer 13, and a memory 16 that stores data used by the single-cycle detector 21, in an operation information outputter 1 according to the present embodiment.

The operation information outputter 1 of the present embodiment is different from the operation information outputter 1 shown in FIGS. 12 to 18 in an operation of the cycle start detector 112 of the single-cycle detector 21; and in that the memory 16 has a pattern waveform storage 103 instead of the condition storage 102. Components similar to those described in the above embodiments are provided with the same numerical references, and illustration thereof is omitted.

The pattern waveform storage 103 stores pattern waveform information indicating a waveform of single-cycle power data.

The single-cycle detector 21 of the present embodiment detects single-cycle power data by detecting a starting point of a single-cycle out of the power data by use of the design cycle time value D_{ct}, a frequency analysis, and pattern matching. As shown in FIG. 19, the cycle start detector 112 of the single-cycle detector 21 includes a pattern matcher 130 and a start time detector 131.

The pattern matcher 130 performs pattern matching (template matching) on the filtered power data acquired from the power data storage 30 via the filtering process executor 123, by use of the filtered power data in a pattern waveform acquired from the pattern waveform storage 103 via the filtering process executor 123.

As a result of the pattern matching, the pattern matcher 130 identifies a portion of the filtered power data that most resembles (matches) the filtered power data in the pattern waveform. Then, the pattern matcher 130 detects a starting point of the identified portion as a reference starting point of a single-cycle. The pattern matcher 130 transmits the detected reference starting point of a single-cycle to the start time detector 131. In the present embodiment, the degree of matching (evaluation standard) is expressed in a correlation coefficient, however, it is also possible to express the degree in a form of known evaluation standards, such as convolution integral.

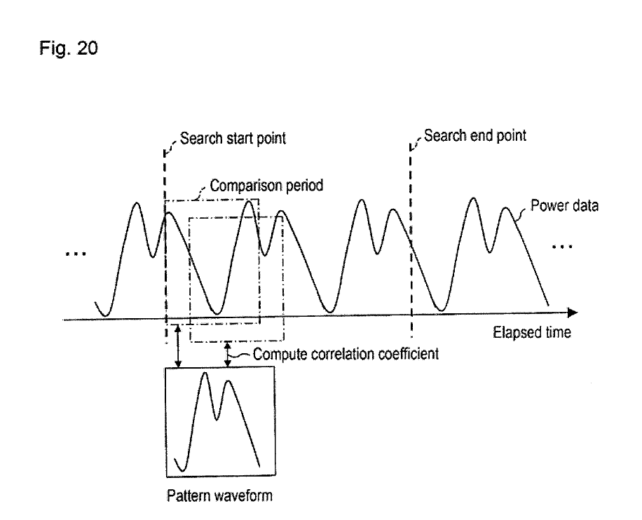

FIG. 20 is a chart illustrating details of the pattern matching. The upper graph in FIG. 20 illustrates a temporal fluctuation in filtered power data. Dashed-dotted lines in the figure each indicate a comparison period. The lower graph in FIG. 20 illustrates a filtered power data in a pattern waveform. The comparison period is the same as the duration of the filtered power data in the pattern waveform.

As shown in FIG. 20, in the present embodiment, first, a search starting point is set at a predetermined point in time, and then a comparison period is set on the downstream side of the search starting point. Next, a correlation coefficient is computed between the power data of the comparison period and the power data in the pattern waveform.

Next, the same process as the above is repeatedly performed while shifting the comparison period to the downstream side until the starting point of the comparison period reaches the search ending point. The starting point of the comparison period having a largest correlation coefficient is determined as a reference starting point of a single-cycle. The determined reference starting point of a single-cycle is transmitted to the start time detector 131.

The search starting point may be a beginning of the filtered power data, or may be a middle thereof. The comparison period may be shifted to the upstream direction, or to the downstream direction. The length of the period from the search starting point to the search ending point may depend on the design cycle time value D_{ct}, for example, twice the length of the design cycle time value D_{ct}, or may be a fixed length. The comparison period may be shifted for every power value, or may be shifted for every group of power values.

The start time detector 131 detects starting points of other single-cycles of filtered power data by use of a reference starting point of a single-cycle output from the pattern matcher 130. The single-cycle detector 21 can detect power data of a single-cycle portion by use of the reference starting point of the single-cycle detected by the pattern matcher 130, and the starting point of the single-cycle detected by the start time detector 131.

The following two methods may be considered as methods, with which the start time detector 131 detects starting points of the other single-cycles. The first method employs the fundamental period T₀, which is a reciprocal of the fundamental frequency f₀, detected by the fundamental frequency detector 121. In this method, the above-described reference starting point of a single-cycle is set as an origin. A point separated by fundamental period T₀ from the origin and subsequent points separated by fundamental period T₀ are detected as the starting points of the other single-cycles. Instead of the fundamental period T₀, a predetermined period corresponding to a cycle time, such as the design cycle time value D_{ct}, may be used.

The second method sets a search starting point and a search ending point, respectively, before and after the starting point of the single-cycle detected by the first method. Then, the second method transmits them to the pattern matcher 130 so as to receive, from the pattern matcher 130, the reference starting point of the single-cycle for the period from the search starting point to the search ending point. Compared with the first method, the second method requires a larger amount of process, but can detect a starting point of a single-cycle with increased accuracy.

It is preferable that the search starting point be a little earlier than the starting point of the single-cycle (0.1 times of the fundamental period T₀, for example). In addition, it is preferable that the search ending point be a point passed a predetermined period (fundamental period T₀, the design cycle time value D_{ct} and the like, for example) from the search starting point.

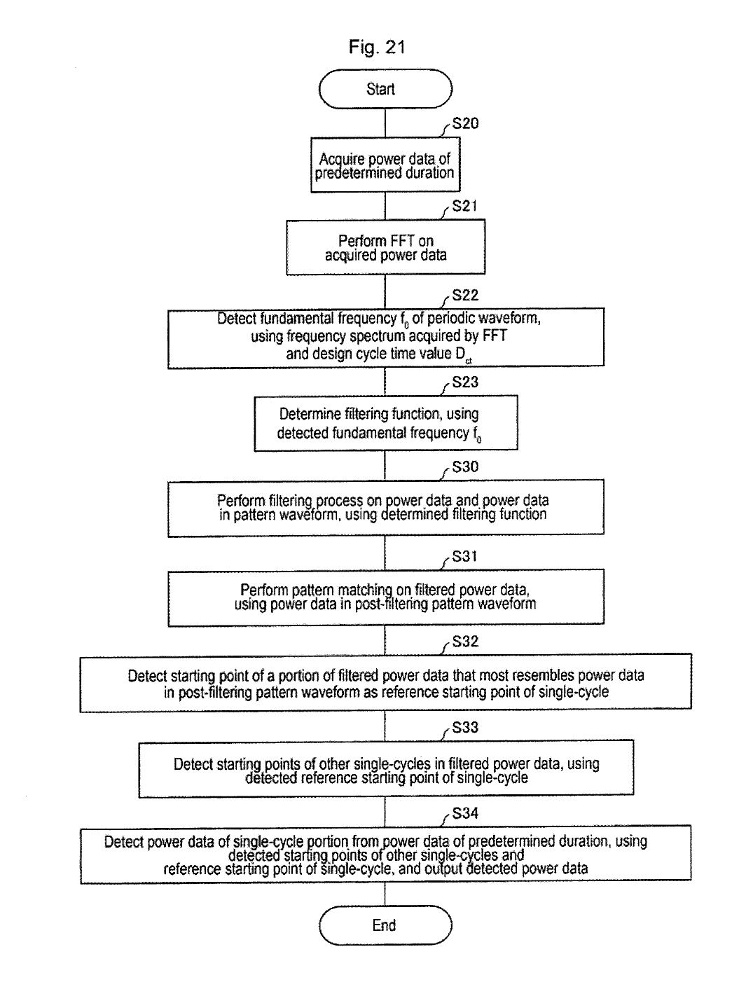

Next, a processing operation in the single-cycle detector 21 of the operation information outputter 1 having the above configuration is described with reference to FIG. 21. FIG. 21 schematically illustrates the processing operation of the single-cycle detector 21. The processes from the acquisition of the power data of predetermined duration from the power data storage 30 (S20) to the determination of the filtering function by the function determiner 122 (S23) is the same as those in FIG. G, thus the illustration thereof is omitted.

After step S23, the filtering process executor 123 performs a filtering process on the power data and the power data in a pattern waveform acquired from the pattern waveform storage 103 by use of the determined filtering function (S30). Next, the pattern matcher 130 performs pattern matching on the filtered power data by use of power data in a post-filtering pattern waveform (S31). Using the result of the pattern matching, the pattern matcher 130 detects a starting point of a portion of the filtered power data that most resembles the power data in a post-filtering waveform as a reference starting point of a single-cycle (S32).

Next, the start time detector 131 detects starting points of other single-cycles in the filtered power data by use of the detected reference starting point of the single-cycle (S33). Then, using the detected stating points of the other single-cycles and reference starting point of the single-cycle, the single-cycle detector 21 detects power data of a single-cycle portion from the power data of predetermined duration acquired from the power data storage 30, and outputs the detected power data (S34). Thereafter, the processing operation is completed.

The pattern waveform storage 103 may store post-filtering pattern waveform information. In such a case, the pattern matcher 130 can directly acquire, from the pattern waveform storage 103, the post-filtering pattern waveform information. It is preferable that the filtering process performed on the pattern waveform information be the same as the filtering process performed by the filtering process executor 123.

### Sixth Embodiment

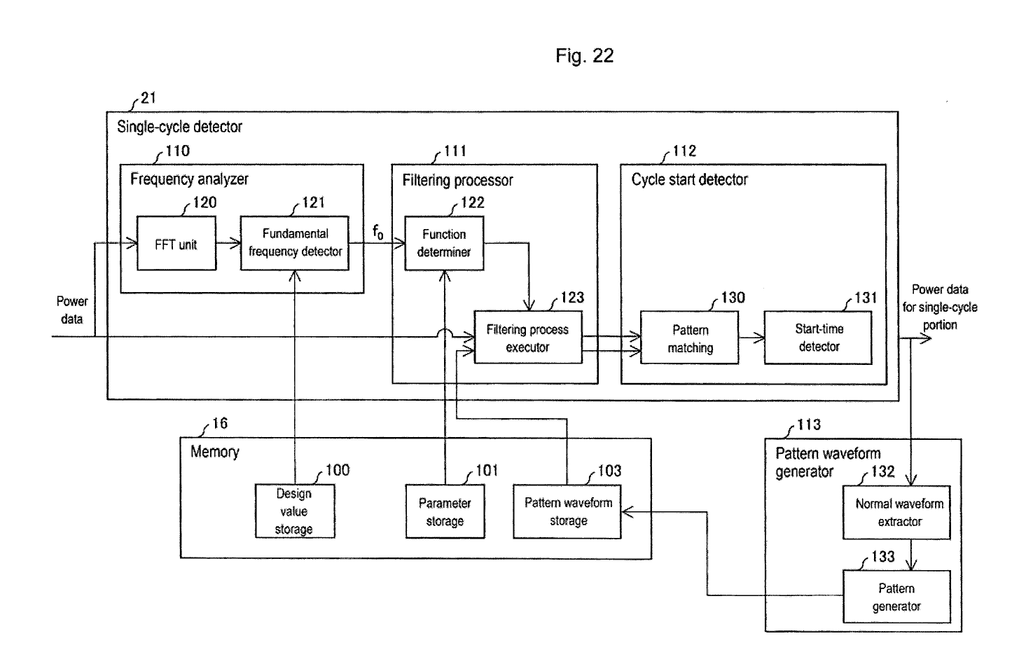

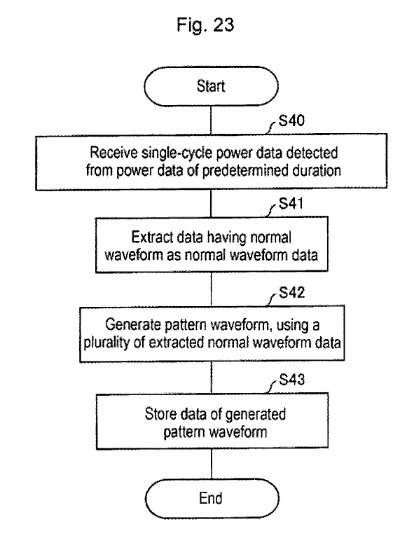

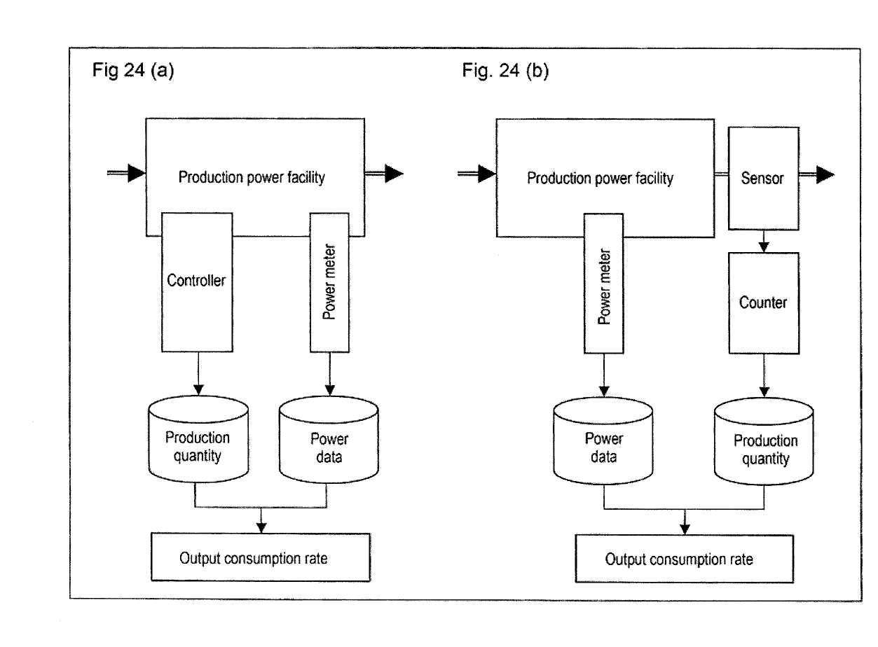

Next, another embodiment of the present invention is described with reference to FIGS. 22 and 23. An operation information outputter 1 of the present embodiment is different from the operation information outputter 1 shown in FIGS. 19 to 21 in that a pattern waveform generator 113 is further provided to the power waveform analyzer 13. Components having functions similar to those described in the above embodiments are provided with the same numerical references, and illustration thereof is omitted.

FIG. 22 illustrates a schematic configuration of the single-cycle detector 21 and the pattern waveform generator 113 included in the power waveform analyzer 13, and the memory 16 that stores data used by the single-cycle detector 21 and the pattern waveform generator 113, in the operation information outputter 1 of the present embodiment. The single-cycle detector 21 is the same as the single-cycle detector 21 shown in FIG. 21, thus the illustration thereof is omitted.

The pattern waveform generator 113 generates a pattern waveform of single-cycle power data by use of single-cycle power data detected by the single-cycle detector 21. As shown in FIG. 22, the pattern waveform generator 113 includes a normal waveform extractor 132 and a pattern generator 133.

The normal waveform extractor 132 receives single-cycle power data from the single-cycle detector 21, and extracts power data having a normal waveform from the received single-cycle power data. Hereinafter, single-cycle power data having a normal waveform is referred to as a normal waveform data. The normal waveform extractor 132 transmits the extracted normal waveform data to the pattern generator 133.

A method, with which the normal waveform extractor 132 determines whether or not a waveform is normal, is described. First, one or more feature amounts Fi that characterize a single-cycle waveform is selected in advance. In this example, a cycle time F1 and a total power of a single-cycle F2 are used as the feature amount Fi. Other examples of the feature amount Fi include basic statistical measurements, specifically, an average, a variance, a standard deviation, a root means square, a maximum value, a minimum value, a kurtosis, a skewness, and the like. The kurtosis indicates a degree of peakedness of a distribution of electric power in a single-cycle with respect to a normal distribution. The skewness indicates a degree of asymmetry of a distribution of electric power in a single-cycle with respect to a normal distribution.

Next, the feature amount Fi is computed for each of the received single-cycle power data. From a set of the computed feature amount Fi, a median mdi and a standard deviation sdi are computed. This process is repeated for each of the feature amount Fi.

Then, single-cycle power data is extracted as a normal waveform data when all the feature amounts Fi of the power data meets the following condition. The condition is that an absolute value abs (Fi−mdi), which is an absolute value of difference between the feature amount Fi and the median mdi, is smaller than the standard deviation sdi. Thereafter, the extracted data is transmitted to the pattern generator 133. In this example, single-cycle power data that satisfies the following condition is extracted:

abs (F1−md1)<sd1, and abs (F2−md2)<sd2.

The pattern generator 133 generates a pattern waveform by use of a plurality of normal waveform data transmitted from the normal waveform extractor 132. More specifically, the pattern generator 133 extracts power values from the plurality of normal waveform data at the time when a same amount of time has elapsed from respective starting points. Then, the pattern generator 133 calculates a median of the extracted plurality of electric power values. The computed median is determined as a power value of a pattern waveform for the elapsed time. A pattern waveform is generated by repeating the above process for all the elapsed time. The pattern generator 133 stores the generated pattern waveform data in the pattern waveform storage 103.

Next, a processing operation in the pattern waveform generator 113 of the operation information outputter 1 in the above configuration is described with reference to FIG. 23. FIG. 23 schematically illustrates the processing operation of the pattern waveform generator 113.

As shown in FIG. 23, first, the normal waveform extractor 132 receives single-cycle power data detected by the single-cycle detector 21 from the power data of predetermined duration (S40), and then extracts the power data having a normal waveform as normal waveform data (S41). Next, the pattern generator 133 generates a pattern waveform by use of a plurality of the extracted normal waveform data (S42), and stores the generated pattern waveform data in the pattern waveform storage 103 (S43). Then, the processing operation is completed.

Thus, in the present embodiment, an appropriate pattern waveform can be automatically acquired even when a pattern waveform is not known in advance.

The single-cycle power data that the pattern waveform generator 113 receives may be data filtered by the filtering processor 111, or may be unfiltered data. The pattern waveform generator 113 may use single-cycle power data detected by other detection methods.

As described above, the consumption rate calculator of the present embodiment includes a physical quantity acquirer that acquires time-series data of a physical quantity consumed or generated when production equipment performs a process; a data detector that detects time-series data of predetermined duration from the time-series data of the physical quantity acquired by the physical quantity acquirer; a production quantity calculator that calculates a production quantity of the objects to be produced by the production equipment for a predetermined time period by use of the time-series data detected by the data detector; and a consumption rate calculator that calculates a consumption rate of the physical quantity by use of the time-series data of the physical quantity for the predetermined time period and the production quantity calculated by the production quantity calculator.

A method for controling the consumption rate calculator according to the present invention includes a physical quantity acquiring step that acquires time-series data of a physical quantity consumed or generated when production equipment performs a process; a data detecting step that detects time-series data of predetermined duration from the time-series data of the physical quantity acquired in the physical quantity acquiring step; a production quantity calculating step that calculates a production quantity of objects to be produced by the production equipment for a predetermined time period by use of the time-series data detected in the data detecting step; and a consumption rate calculating step that calculates a consumption rate of the physical quantity by use of the time-series data of the physical quantity for the predetermined time period and the production quantity calculated in the production quantity calculating step.

Examples of the predetermined duration include, for example, a design cycle time value of the production equipment.

According to the above-described configuration or method, time-series data of a physical quantity that is consumed or generated when production equipment performs a process is acquired. Then, time series data of predetermined duration is detected from the time-series data of the physical quantity. By using the detected time-series data, a production quantity of the production equipment for a specific time period is calculated. Then, a consumption rate of the physical quantity is calculated based on the acquired time-series data of the physical quantity and the production quantity.

Thus, it is possible to calculate a consumption rate of the physical quantity based only on the acquired time-series data of the physical quantity. Therefore, a consumption rate of a physical quantity can be easily calculated without adding another device for calculating a consumption rate of a physical quantity or changing a ladder program of a PLC.

In the consumption rate calculator according to the present invention, a physical quantity may be an electric energy amount or an electric current value.

An amount of electric energy consumed by production equipment or an electric current value can be measured with an existing power meter in many cases. Alternatively, a power meter can be easily installed in production equipment in many cases. Therefore, a physical quantity can be acquired with a simple configuration when the physical quantity is an amount of electric energy or an electric current value.

In the consumption rate calculator according to the present invention, the consumption rate calculator may calculate a power consumption rate, which is a consumption rate of electric energy consumed by production equipment.

With the above-described configuration, it is possible to calculate a power consumption rate, thus a user can easily recognize power usage efficiency.

In the consumption rate calculator according to the present invention, it is preferable that the data detector detect a single-cycle portion of time-series data of a physical quantity acquired by the physical quantity acquirer, in a case where a single-cycle is a period from a start to an end of a process performed by production equipment on one object to be produced.

With the above-described configuration, it is possible to calculate a cycle time, which is a time from a start to an end of a process with respect to one object to be produced in a production line, by detecting a single-cycle portion. In addition, it is also possible to calculate a production quantity based on the cycle time.

The consumption rate calculator of the present invention may include a product type determiner that determines types of production objects, on which production equipment performs a process. Further, the consumption rate calculator may calculate a consumption rate of a physical quantity for each product type using the determination result by the product type determiner.

With the above-described configuration, it is possible to calculate a physical quantity consumption rate for each type of production objects, on which production equipment performs a process. Thus, for example, a user can recognize the physical quantity consumption rate for each product type. Therefore, the user can understand production efficiency for each product type based on the physical quantity consumption rate for each product type, and take a measure for improving productivity per product type.

In the consumption rate calculator of the present invention, a physical quantity may be vibration energy in production equipment generated when the production equipment performs processing steps. The consumption rate calculator may calculate a vibration consumption rate, which is a consumption rate of the vibration energy.

With the above-described configuration, it is possible to calculate a vibration consumption rate, which is a consumption rate of vibration energy in production equipment generated when the production equipment performs processing steps. This allows a user to recognize an amount of vibration generated by a process on a predetermined amount of products.

The consumption rate calculator according to the present invention may include a display and a display controller that displays on the display a level of a consumption rate calculated by the consumption rate calculator.

With the above-described configuration, it is possible to display a level of a consumption rate on the display. Thereby, a user can easily recognize the level of a consumption rate.

The consumption rate calculator according to the present invention may include a display and a display controller that displays on the display consumption rates for a plurality of production lines.

With the above-described configuration, it is possible to display consumption rates of a plurality of production lines. Thus, a user can easily recognize a consumption rate for each production line.

The consumption rate calculator may be configured with a computer. In such a case, the present invention includes a program that controls the consumption rate calculator that executes, by a computer, a method to control the consumption rate calculator by operating the computer as the above each step, and a computer-readable storage medium that stores the program.

The present invention is not limited to the above described each embodiment, and various modifications may be possible within the scope of the claims. Embodiments obtained by arbitrarily combining features disclosed in each different embodiment are also included in the technical scope of the present invention.

Lastly, each component of the operation information outputter 1, especially, the power waveform analyzer 13, the operation information controller 14, the vibration waveform analyzer 18, the power-consumption-rate calculator 27, the vibration-consumption-rate calculator 28, and the air-consumption-rate calculator 29 may be configured with a hardware logic, or a software employed along with a CPU (central processing unit) as described in the following.

Specifically, the operation information outputter 1 includes a CPU that executes instructions of a control program that executes each function; a ROM (read only memory) that stores the program; a RAM (random access memory), in which the program is executed; a storage (recording medium), such as a memory, that stores the program and various data; and the like. The operation information outputter 1 is provided with a recording medium that stores computer-readable program codes (an executable program, an intermediate code program, and a source program) of the control program of the operation information outputter 1, the control program being software to execute the above functions. Further, a computer (alternatively, CPU or MPU (microprocessor unit)) reads out and executes the program codes stored in the recording medium. Thereby, the object of the present invention can be also achieved.

Examples of the recording medium include, for example, a tape, such as a magnetic tape, a cassette tape, and the like; a disc including an magnetic disk such as a floppy (a registered trademark) disc, a hard disc and the like, and an optical disc such as a CD-ROM (compact disc read-only memory), MO (magneto-optical), MD (Mini Disc), DVD (digital versatile disc), CD-R (CD Recordable) and the like; a card, such as an IC card (including a memory card), an optical card, and the like; a semiconductor memory, such as a mask ROM, EPROM (erasable programmable read-only memory), EEPROM (electrically erasable and programmable read-only memory), a flash ROM; and the like.

The operation information outputter 1 may be configured to be connectable to a communication network, thorough which the program codes may be provided. The communication network is not limited to a specific type, and may be configured with, for example, the internet, an intranet, an extranet, LAN (local area network), ISDN (integrated services digital network), VAN (value-added network), CATV (community antenna television) communication network, a virtual private network, a telephone network, a mobile communication network, a satellite communication network, or the like. A transmission medium that configures the communication network is not limited to a specific type, and may be configured with, for example, a wired medium, such as an IEEE (institute of electrical and electronic engineers) 1394, a USB, a power-line carrier, a cable TV line, a telephone line, an ADSL (a synchronous digital subscriber loop) line and the like; and a wireless medium, such as an infrared ray including an IrDA (infrared data association) and a remote controller, a Bluetooth (a registered trademark), an 802.11 wireless LAN, an HDR (high data rate), a mobile communication network, a satellite connection network, a digital terrestrial communication, and the like. The present invention can be also executed by an electronic transmission of the program code, such as a computer data signal embedded in the transmitted wave.

It is noted that the foregoing examples have been provided merely for the purpose of explanation and are in no way to be construed as limiting of the present invention. Changes may be made, within the purview of the appended claims, as presently stated, without departing from the spirit of the present invention.

### INDUSTRIAL APPLICABILITY

The present invention detects a single-cycle of production equipment based on time-series data of a physical quantity consumed or generated by production equipment in a production line, thus is suitable for a machine that outputs an operation information that can be calculated and determined by use of the single-cycle.

[Description of Reference Numerals]

1 Operation information outputter (Consumption rate calculator)

2 Power meter

3 Production equipment

5 Production line

11 Power data acquirer (Physical quantity acquirer)

14 Operation information controller (Display controller)

17 Operation data acquirer (Physical quantity acquirer)

20 Operation information acquirer

21 Single-cycle detector (Data detector)

22 Product-type determiner

23 Cycle-time calculator

24 Production-quantity calculator

25 Operation-stat-time calculator

26 Load-state-time calculator

27 Power-consumption-rate calculator (Consumption rate calculator)

28 Vibration-consumption-rate calculator (Consumption rate calculator)

29 Air-consumption-rate calculator (Consumption rate calculator)

51 Stop-state-time calculator

1. A consumption rate calculator comprising:
a physical quantity acquirer that acquires time-series data of a physical quantity consumed or generated when production equipment performs a process;
a data detector that detects time-series data of predetermined duration from the time series data of the physical quantity acquired by the physical quantity acquirer;
a production quantity calculator that calculates the production quantity of objects to be produced by the production equipment in a specific period, using the time-series data detected by the data detector; and
a consumption rate calculator that calculates a consumption rate of the physical quantity using the time-series data of the physical quantity for the specific period and the production quantity calculated by the production quantity calculator.

2. The consumption rate calculator according to claim 1, wherein the physical quantity is an electric energy amount or an electric current value.

3. The consumption rate calculator according to claim 1, wherein the consumption rate calculator calculates a power consumption rate that is a consumption rate of total power consumption of the production equipment.

4. The consumption rate calculator according to claim 1, wherein the data detector detects the single-cycle portion from the time-series data of the physical quantity acquired by the physical quantity acquirer in a case where a single cycle is a period from a start to an end of a process on one object to be produced by the production equipment.

5. The consumption rate calculator according to claim 1, comprising:
a product-type determiner that determines a type of the object to be produced, on which the production equipment performs a process, and
wherein the consumption rate calculator calculates the consumption rate of the physical quantity for each product type using a determined result by the product type determiner.

6. The consumption rate calculator according to claim 1, wherein the physical quantity is vibration energy generated in the production equipment when the production equipment performs the process, and
the consumption rate calculator calculates a vibration consumption rate that is a consumption rate of the vibration energy.

7. The consumption rate calculator according to claim 1, comprising:
a display, and
wherein the display includes a display controller that displays a level of a consumption rate calculated by the consumption rate calculator.

8. The consumption rate calculator according to claim 1, comprising:
a display, and
wherein the display includes a display controller that displays consumption rates of a plurality of production lines.

9. A non-transitory computer readable storage medium having computer instructions stored thereon comprising a program for controlling a consumption rate calculator that calculates a physical quantity consumption rate of production equipment, the program causing a computer to perform:
a physical quantity acquisition that acquires the physical quantity consumed or generated when the production equipment performs a process;
a data detection that detects time-series data of predetermined duration from time-series data of the physical quantity acquired in the physical quantity acquisition;
a production quantity calculation that calculates a production quantity of objects to be produced by the production equipment in a specific period, using the time-series data detected in the data detection; and
a consumption rate calculation that calculate a consumption rate of the physical quantity using the time-series data of the physical quantity for the specific period and the production quantity calculated in the production quantity calculation.

10. A method that controls a consumption rate calculator comprising:
acquiring time-series data of a physical quantity consumed or generated when production equipment performs a process;
detecting time-series data of predetermined duration from the time-series data of the physical quantity acquired in the physical quantity acquisition;
calculating a production quantity of objects to be produced by the production equipment in a specific period, using the time-series data detected in the data detection; and
calculating a consumption rate of the physical quantity, using the time-series data of the physical quantity for the specific period and the production quantity calculated in the production quantity calculation.

11. The consumption rate calculator according to claim 2, wherein the consumption rate calculator calculates a power consumption rate that is a consumption rate of total power consumption of the production equipment.

12. The consumption rate calculator according to claim 2, wherein the data detector detects the single-cycle portion from the time-series data of the physical quantity acquired by the physical quantity acquirer in a case where a single cycle is a period from a start to an end of a process on one object to be produced by the production equipment.

13. The consumption rate calculator according to claim 3, wherein the data detector detects the single-cycle portion from the time-series data of the physical quantity acquired by the physical quantity acquirer in a case where a single cycle is a period from a start to an end of a process on one object to be produced by the production equipment.

14. The consumption rate calculator according to claim 2, comprising:
a product-type determiner that determines a type of the object to be produced, on which the production equipment performs a process, and
wherein the consumption rate calculator calculates the consumption rate of the physical quantity for each product type using a determined result by the product type determiner.

15. The consumption rate calculator according to claim 3, comprising:
a product-type determiner that determines a type of the object to be produced, on which the production equipment performs a process, and
wherein the consumption rate calculator calculates the consumption rate of the physical quantity for each product type using a determined result by the product type determiner.

16. The consumption rate calculator according to claim 4, comprising:
a product-type determiner that determines a type of the object to be produced, on which the production equipment performs a process, and
wherein the consumption rate calculator calculates the consumption rate of the physical quantity for each product type using a determined result by the product type determiner.

17. The consumption rate calculator according to claim 4, wherein the physical quantity is vibration energy generated in the production equipment when the production equipment performs the process, and
the consumption rate calculator calculates a vibration consumption rate that is a consumption rate of the vibration energy.

18. The consumption rate calculator according to claim 5, wherein the physical quantity is vibration energy generated in the production equipment when the production equipment performs the process, and
the consumption rate calculator calculates a vibration consumption rate that is a consumption rate of the vibration energy.

19. The consumption rate calculator according to claim 2, comprising:
a display, and
wherein the display includes a display controller that displays a level of a consumption rate calculated by the consumption rate calculator.

20. The consumption rate calculator according to claim 2, comprising:
a display, and
wherein the display includes a display controller that displays consumption rates of a plurality of production lines.
